(19) United States
(12) Patent Application Publication
(10) Pub. No.: US 2011/0141429 A1
(43) Pub. Date: Jun. 16, 2011

(54) CELLULOSE ACYLATE FILM, METHOD FOR PRODUCING CELLULOSE ACYLATE FILM, POLARIZER AND LIQUID CRYSTAL DISPLAY DEVICE

(75) Inventors: Yoshiaki HISAKADO, Minami-ashigara-shi (JP); Makoto ISHIGURO, Minami-ashigara-shi (JP); Takahiro OHNO, Minami-ashigara-shi (JP)

(73) Assignee: FUJIFILM Corporation, Tokyo (JP)

(21) Appl. No.: 12/966,648

(22) Filed: Dec. 13, 2010

(30) Foreign Application Priority Data
Dec. 14, 2009 (JP) 2009-282653

(51) Int. Cl. G02F 1/1333; C09K 19/00; C09K 19/06; C09K 19/34; G02B 5/30

(52) U.S. Cl. 349/158; 428/1.33; 252/299.6; 252/299.61; 359/483.01

(57) ABSTRACT

A cellulose acylate film including a cellulose acylate and a sugar ester compound, which is stretched at (Tg−5° C.) to (Tg+10° C.) while as yet not heated at all at (Tg−5° C.) or higher and which has a total haze of at most 1.0% and an internal haze of at most 0.1%, wherein Tg means the glass transition temperature (unit: ° C.) of the cellulose acylate film.

### CROSS-REFERENCE TO RELATED APPLICATIONS

The present application claims the benefit of priority from Japanese Patent Application No. 282653/2009 filed on Dec. 14, 2009, the contents of which are herein incorporated by reference in their entirety.

### BACKGROUND OF THE INVENTION

1. Field of the Invention

The present invention relates to a cellulose acylate film, a method for producing cellulose acylate, and to a polarizer and a liquid crystal display device produced by the use of the cellulose acylate film. Especially, the present invention relates to a cellulose acylate film which can be preferably used as an optimal film such as a retardation film or the like.

2. Description of the Related Art

With recent development of TV application of liquid crystal display devices, high-definition, low-cost and large-size display panels are required much more. In particular, VA-mode liquid crystal display devices have a relatively high contrast and their production yield is relatively high, and therefore they are the most popular as liquid crystal display devices for TV application.

However, a VA-mode liquid crystal display device has a problem in that, at the time of black level of display, the device could give a relatively good black display in the normal direction to the display panel thereof, but when the black display is seen in an oblique direction to the panel, then there occurs light leakage to fail in background black display on the panel and therefore the viewing angle is narrow. Accordingly, these days desired is an optical film capable of exhibiting viewing angle compensation by itself when incorporated in a liquid crystal display device in order that the optical film of the type is used as the polarizer protective film capable of realizing optical compensation capability through retardation expression in the display device. Also desired is further improvement of the display performance of liquid crystal display devices, for which is desired an optical film capable of further increasing the contrast of display.

Various types of cellulose acylate films are used for such optical films having optical compensation capability, and cellulose acylate films with various additives are known. Cellulose acylate films are produced according to various film formation methods; and for enhancing the retardation of optical films having optical compensation capability, generally employed is a method of stretching the films.

WO2008-126535 discloses a film produced by solution-casting a cellulose acylate and a plasticizer, which is stretched after heat treatment at (Tg+10° C.) to (Tg+40° C.) and of which therefore both the total haze and the internal haze are reduced and the front contrast is increased. Precisely, in Examples in WO2008-126535, a polyester-based plasticizer and a polyalcohol-based plasticizer are used together and the film is, before stretched, once heated at a temperature higher than the stretching temperature and then stretched. Accordingly, the film exhibits a good front contrast when incorporated in a liquid crystal display device, but requires the heat treatment step at a fairly high temperature higher than the stretching temperature; and therefore, in consideration of the equipment and the running cost, the film is unsatisfactory from the viewpoint of reducing the production cost thereof. In addition, heat treatment at high temperature detracts from the retardation expressibility of the cellulose acylate film, and therefore, in order to make the film express the desired retardation, the film thickness must be increased or the amount of the retardation enhancer must be increased, and the film is unsatisfactory from the viewpoint of the material cost.

WO2008-126535 discloses no example of using a sugar ester compound and has no specific description relating to the performance of films produced by the use of a sugar ester compound.

### SUMMARY OF THE INVENTION

The present inventors investigated the film and its production method described in WO2008-126535, and have known that the film produced by the use of the compound employed in Examples in the patent reference surely has an increased haze when the film is stretched with no heat treatment at high temperature.

In fact at present, a film capable of being produced at low cost and capable of increasing the front contrast when incorporated in a liquid crystal display device is heretbfore unknown in the art.

The present invention is to solve the above-mentioned problems. Specifically, an object of the invention is to provide a cellulose acylate film capable of being produced at low cost and capable of attaining good contrast when incorporated in a liquid crystal display device as a retardation film therein.

Given the situation, the present inventors have assiduously studied and, as a result, have surprisingly found that, when a sugar ester compound is used as a plasticizer and when the film is stretched within a specific, extremely-narrow temperature range, then the film can enhance the front contrast even though it is not heat-treated at a high temperature prior to the stretching. Specifically, the inventors have found that, when a specific plasticizer is used and when the film is stretched within a specific temperature range, then a cellulose acylate film capable of realizing a good contrast when incorporated in a liquid crystal display device as a retardation film therein can be produced at a low cost, and have completed the present invention.

Concretely, the following means solved the above-mentioned problems.

[1] A cellulose acylate film comprising a cellulose acylate and a sugar ester compound, which is stretched at (Tg−5° C.) to (Tg+10° C.) while as yet not heated at all at (Tg−5° C.) or higher and which has a total haze of at most 1.0% and an internal haze of at most 0.1%, wherein Tg means the glass transition temperature (unit: ° C.) of the cellulose acylate film.
[2] The cellulose acylate film of [1], wherein the sugar ester compound comprises from 1 to 12 units of a pyranose structural unit or a furanose structure unit in which at least one hydroxyl group is esterified.
[3] The cellulose acylate film of [1] or [2], which has a total haze of at most 0.4%.
[4] The cellulose acylate film of any one of [1] to [3], wherein the cellulose acylate satisfies the following formulae (1) and (2):

2.00≦A+B≦2.80 (1)

0.50≦B (2)

wherein A means a degree of acetyl substitution, and B means a degree of propionyl substitution or butyryl substitution.
[5] The cellulose acylate film of any one of [1] to [4], of which the in-plane retardation at a wavelength of 590 nm Re(590) and the thickness-direction retardation at a wavelength of 590 nm Rth(590) satisfy the following formulae (3) and (4):

30 nm≦Re(590)≦90 nm (3)

90 nm≦Rth(590)≦150 nm. (4)

[6] The cellulose acylate film of anyone of [1] to [5], which comprises a polyester-based plasticizer.
[7] A method for producing an optical film, which comprises stretching a film comprising a cellulose acylate and a sugar ester compound at (Tg−5° C.) to (Tg+10° C.) while as yet the film is not heated at all at (Tg−5° C.) or higher, wherein Tg means the glass transition temperature (unit: ° C.) of the cellulose acylate film.
[8] The method for producing an optical film of [7], wherein the sugar ester compound comprises from 1 to 12 units of a pyranose structural unit or a furanose structure unit in which at least one hydroxyl group is esterified.
[9] The method for producing an optical film of [7] or [8], wherein the stretching temperature is from (Tg−5° C.) to (Tg+5° C.) wherein Tg means the glass transition temperature of the cellulose acylate film.
[10] A cellulose acylate film produced by the method for producing a cellulose acylate film of any one of [7] to [9].
[11] A polarizer comprising a polarizing element and at least one cellulose acylate film of any one of [1] to [6] and [10].
[12] A liquid crystal display device comprising at least one of the cellulose acylate film of any one of [1] to [6] and [10] or the polarizer of [11].
[13] The liquid crystal display device of [12], which comprises a VA-mode liquid crystal cell, a front-side substrate and a rear-side substrate and wherein the ratio of the part contrast of the front-side substrate (CR_{f}) to the part contrast of the rear-side substrate (CRᵣ), (CR_{f}/CRᵣ) is from 0.3 to 2.8.

According to the invention, there are provided a cellulose acylate film capable of securing a good contrast when incorporated in a liquid crystal display device as a retardation film therein and capable of being produced at a low production cost, and a method for producing the film.

### BRIEF DESCRIPTION OF THE DRAWINGS

FIG. 1 is a schematic cross-sectional view of an example of the VA-mode liquid crystal display devices of the invention.

FIG. 2 is a schematic cross-sectional view of an example of the VA-mode liquid crystal cells.

In the drawings, 10 denotes back light, 12 and 14 denotes polarizing element, 16 denotes first retardation film (first retardation region), 18 denotes second retardation film (second retardation region), 20 and 22 denotes outer protective film, 24 denotes rear-side substrate, 26 denotes front-side substrate, 28 denotes color filter member, 29 denotes liquid crystal layer, 30 denotes array member, LC denotes VA-mode liquid crystal cell, PL1 denotes rear-side polarizer, PL2 denotes front-side polarizer.

### BEST MODE FOR CARRYING OUT THE INVENTION

Description will now be made in detail of the present invention. Although the following description of its structural features may often be made on the basis of typical embodiments of the invention, it is to be understood that the invention is not limited to any such embodiment. It is also to be noted that every numerical range as herein expressed by employing the words “from” and “to”, or simply the word “to”, or the symbol “˜” is supposed to include the lower and upper limits thereof as defined by such words or symbol, unless otherwise noted. In the invention, “mass %” means equal to “weight %”, and “% by mass” means equal to “% by weight”.

In this description, the “front side” means the panel side; and the “rear side” means the backlight side. In this description, the “front” means the normal direction to the panel face; and the “front contrast ratio (CR)” means the contrast ratio computed from the white brightness and the black brightness measured in the normal direction to the panel face.

### [Cellulose Acylate Film]

The cellulose acylate film of the invention (this may be referred to as the film of the invention below) contains a cellulose acylate and a sugar ester compound, which is stretched at (Tg−5° C.) to (Tg+10° C.) while as yet not heated at all at (Tg−5° C.) or higher and which has a total haze of at most 1.0% and an internal haze of at most 0.1%, wherein Tg means the glass transition temperature (unit: ° C.) of the cellulose acylate film.

The film of the invention is described below.

### (Cellulose Acylate)

Preferably, cellulose acylate is used in the invention.

The cellulose acylate includes triacetyl cellulose (TAC), diacetyl cellulose (DAC), cellulose acetate propionate (CAP), cellulose acetate butyrate (CAB), cellulose acetate phthalate, etc. Preferred is cellulose acetate propionate.

Preferably, the molecular weight of the cellulose acylate is from 40000 to 200000 in terms of the number-average molecular weight (Mn) thereof, more preferably from 100000 to 200000. Also preferably, the ratio of Mw/Mn of the cellulose acylate for use in the invention is at most 4.0, more preferably from 1.4 to 2.3.

In the invention, the mean molecular weight and the molecular weight distribution of cellulose acylate or the like may be determined by computing the number-average molecular weight (Mn) and the weight-average molecular weight (Mw) thereof through gel permeation chromatography (GPC) followed by computing the ratio of the resulting data according to the method described in WO2008-126535.

The cellulose acylate for use in the invention preferably satisfies the following formulae (1) and (2) from the viewpoint of reducing the total haze and the internal haze of the film and increasing the front contrast when incorporated in a liquid crystal display device.

2.00≦A+B≦2.80 (1)

0.50≦B (2)

wherein A means a degree of acetyl substitution, and B means a degree of propionyl substitution or butyryl substitution.

In particular, more preferred is cellulose acylate propionate with 2.0≦A+B≦2.6 where (A+B) means the degree of total acyl substitution of the ester, even more preferably with 2.1≦A+B≦2.6, still more preferably with 0.5≦B≦2.0, further preferably with 0.8≦B≦1.8.

The degree of substitution with acyl group may be determined according to the method stipulated in ASTM-D817-96. The part not substituted with an acyl group is generally a hydroxyl group. These cellulose esters may be produced according to known methods.

### (Haze)

The total haze of one sheet of the cellulose acylate film of the invention is at most 1.0%, and the internal haze thereof is at most 0.1%.

The total haze is the haze value (%) measured according to JIS K7136. The internal haze may be measured as follows: A few drops of glycerin are applied onto both surfaces of the cellulose acylate film to be analyzed, the film is sandwiched between two glass plates (MICRO SLIDE GLASS Lot No. 59213, by Matsunami) each having a thickness of 1.3 mm, and the haze value (%) of the sample is measured. On the other hand, a few drops of glycerin are put between two glass plates, and the haze value (%) thereof is measured. The latter value is subtracted from the former value to give the internal haze value (%).

To measure the haze thereof, the cellulose acylate film is conditioned in an atmosphere at 23° C. and a relative humidity of 55% for 24 hours, and its haze is measured in the same environment using a haze meter (Nippon Denshoku Kogyo's NDH2000).

Preferably, the total haze of the cellulose acylate film of the invention is at most 0.4%, more preferably from 0 to 0.30%.

Preferably, the internal haze of the cellulose acylate film of the invention is at most 0.05%, more preferably at most 0.04%, even more preferably at most 0.03%.

In general, it is said that the haze is preferably lower. However, only the low haze is insufficient for improving the front contrast; and the present inventors have specifically controlled the internal haze of the film in addition to the total haze thereof, and have succeeded in improving the front contrast of liquid crystal display devices.

### (Glass Transition Temperature Tg of Cellulose Acylate Film)

The glass transition temperature Tg of the cellulose acylate film of the invention means the glass transition temperature (abbreviated as Tg below) of the entire film that contains cellulose acylate, plasticizer and other additives constituting the film.

Tg may be measured as follows: 10 mg of the film to be analyzed is melted at 300° C. in a nitrogen stream running at 300 cm³/min, and then immediately rapidly cooled in liquid nitrogen. The rapidly-cooled sample is set in a differential scanning calorimeter (Rigaku Denki's DSC8230 Model), heated in a nitrogen stream running at 100 ml/min, at a heating rate of 10° C./min, and Tg of the sample is thus detected. Tg is the mean value of the temperature at which the base line has started to deviate and the temperature at which the base line has restored. The temperature at which the measurement is started is a temperature lower by at least 50° C. than Tg of the sample (the heating start temperature is room temperature).

### (Re, Rth)

Preferably, the in-plane retardation at a wavelength of 590 nm Re(590) and the thickness-direction retardation at a wavelength of 590 nm Rth(590) of the film of the invention satisfies the following formulae (3) and (4):

30 nm≦Re(590)≦90 nm (3)

90 nm≦Rth(590)≦150 nm. (4)

More preferably, Re(590) is from 30 to 80 nm, even more preferably from 35 to 70 nm, still more preferably from 40 to 60 nm.

More preferably, Rth(590) is from 95 to 145 nm.

Preferably, the film of the invention is a biaxial optical compensatory film.

The biaxial optical compensatory film means that nx, ny and nz of the optical compensatory film all differ from each other, in which nx means the refractive index in the in-plane slow axis direction, ny means the in-plane refractive index in the direction perpendicular to nx, and nz means the refractive index in the direction perpendicular to nx and ny. More preferably in the invention, nx>ny>nz.

The film of the invention having the biaxial optical property is preferred in that, when it is incorporated in a liquid crystal display device, especially in a VA-mode liquid crystal display device and when the device is watched in an oblique direction, the problem of color shift can be reduced.

Re(A) and Rth(A) represent, herein, the retardation in the in-plane and the retardation in the thickness direction, respectively, at a wavelength of λ. In the invention, λ is 590 nm if there is no description. Re(λ) is measured with KOBRA 21ADH (by Oji Scientific Instruments) while allowing light having the wavelength of λ nm to enter in the normal direction of a film. With the in-plane slow axis (determined by KOBRA 21ADH) taken as the inclination axis (rotation axis) of the sample (in the case where the sample has no slow axis, the rotation axis of the sample may be in any in-plane direction of the sample), Re(λ) of the sample is measured at 6 points in all thereof, up to +50° relative to the normal line direction of the sample at intervals of 10°, by applying a light having a wavelength of λ nm from the inclined direction of the sample. With the slow axis taken as the inclination axis (rotation axis) (in the case where the sample has no slow axis, the rotation axis of the sample may be in any in-plane direction of the film), the retardation values of the sample are measured in any inclined two directions; and based on the data and the mean refractive index and the inputted thickness of the sample, Rth may be calculated according to the following formulae (A) and (B). The mean refractive index may be used values described in Polymer Handbook (JHON WILEY&SONS, INC.) or catalogs for various types of optical films. When the mean refractive index has not known, it may be measured with Abbe refractometer. The mean refractive index for major optical film is described below: cellulose acetate (1.48), cycloolefin polymer (1.52), polycarbonate (1.59), polymethylmethacrylate (1.49), polystyrene (1.59). By inputting the value of these average refraction indices and thickness, KOBRA 21ADH computes nx, ny, nz. From the computed nx, ny, nz, Nz=(nx−nz)/(nx−ny) is computed further.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( A )$$

The above Re(θ) represents the retardation in a direction that inclines in the degree of θ from the normal direction; and d is a thickness of the film.

Rth={(nx+ny)/2−nz}×d Formula (B)

In this, the mean refractive index n is needed as a parameter, and it is measured with an Abbe refractiometer (Atago's Abbe Refractiometer 2-T).

### (Layer Constitution of Cellulose Acylate Film)

The film of the invention may be a single-layer film or may have a laminate structure of two or more layers, but is preferably a single-layer film.

### (Film Thickness)

Preferably, the film of the invention has a thickness of from 20 to 90 μm from the viewpoint of reducing the production cost, more preferably from 25 to 80 μm, even more preferably from 25 to 60μ. In the case where the film of the invention is a laminate film, the overall film thickness preferably falls within the above range.

### (Film Width)

Preferably, the film width of the invention is at least 1000 mm, more preferably at least 1500 mm, even more preferably at least 1800 mm.

### <Additive>

### (1) Sugar Ester Compound:

The film of the invention contains a sugar ester compound.

Adding a sugar ester compound to the cellulose acylate film may reduce the total haze and the internal haze of the film even in the presence of heat treatment prior to stretching the film, not detracting from the ability of the film to express the optical properties thereof. Further, when the cellulose acylate film of the invention is used in a liquid crystal display device, the front contrast can be significantly improved.

### —Sugar Residue—

The sugar ester compound means a compound where at least one substitutable compound (for example, hydroxyl group, carboxyl group) in the monose or polyose constituting the compound is ester-bonded to at least one substituent herein. Specifically, the sugar ester compound as referred to herein includes sugar derivatives in a broad sense of the word, and for example, include compounds having a sugar residue as the structural unit thereof such as gluconic acid. Concretely, the sugar ester compound includes an ester of glucose and a carboxylic acid, and an ester of gluconic acid and an alcohol.

The substitutable group in the monose or polyose constituting the sugar ester compound is preferably a hydroxyl group.

The sugar ester compound includes a monose or polyose-derived structure (this may be referred to as a sugar residue below) that constitutes the sugar ester compound. The structure per monose of the sugar residue is referred to as the structural unit of the sugar ester compound. The structural unit of the sugar ester compound preferably includes a pyranose structural unit or a furanose structural unit, more preferably, all the structural units thereof are pyranose structural units or furanose structural units. In the case where the sugar ester is formed of a polyose, it preferably includes both a pyranose structural unit and a furanose structural unit.

The sugar residue of the sugar ester compound may be a pentose-derived one or a hexose-derived one, but is preferably a hexose-derived one.

Preferably, the number of the structural units contained in the sugar ester compound is from 1 to 12, more preferably from 1 to 6, even more preferably 1 or 2.

In the invention, preferably, the sugar ester compound contains from 1 to 12 pyranose structural units or furanose structural units in which at least one hydroxyl group is esterified, even more preferably, one or two pyranose structural units or furanose structural units in which at least one hydroxyl group is esterified.

Examples of monoses or polyoses containing from 2 to 12 monose units include, for example, erythrose, threose, ribose, arabinose, xylose, lyxose, arose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, baltopentaose, belbalcose, maltohexaose, α-cyclodextrin, β-cyclodextrin, γ-cyclodextrin, δ-cyclodextrin, xylitol, sorbitol, etc.

Preferred are ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol, sorbitol; more preferred are arabinose, xylose, glucose, fructose, mannose, galactose, maltose, cellobiose, sucrose, β-cyclodextrin, γ-cyclodextrin; and even more preferred are xylose, glucose, fructose, mannose, galactose, maltose, cellobiose, sucrose, xylitol, sorbitol.

### —Structure of Substituent—

More preferably, the sugar ester compound for use in the invention has, including the substituent therein, a structure represented by the following formula (1):

(OH)ₚ-G-(L¹-R¹¹)_{q}(O—R¹²)ᵣ (1)

wherein G represents a sugar residue; L¹ represents any one of —O—, —CO— or —NR¹³—; R¹¹ represents a hydrogen atom or a monovalent substituent; R¹² represents a monovalent substituent bonding to the formula via an ester bond; p, q and r each independently indicate an integer of 0 or more, and p+q+r is equal to the number of the hydroxyl groups on the presumption that G is an unsubstituted sugar group having a cyclic acetal structure.

The preferred range of G is the same as the preferred range of the above-mentioned sugar residue.

L¹ is preferably —O— or —CO—, more preferably —O—. When L¹ is —O—, it is more preferably an ether bond or ester bond-derived linking group, even more preferably an ester bond-derived linking group.

In the case where the formula has two or more L¹'s, then they may be the same or different.

Preferably, at least one of R¹¹ and R¹² has an aromatic ring.

In particular, in the case where L¹ is —O— (or that is, in the case where the hydroxyl group in the above-mentioned sugar ester compound is substituted with R¹¹ and R¹²), preferably, R¹¹, R¹² and R¹³ are selected from a substituted or unsubstituted acyl group, a substituted or unsubstituted aryl group, a substituted or unsubstituted alkyl group, or a substituted or unsubstituted amino group, more preferably from a substituted or unsubstituted acyl group, a substituted or unsubstituted alkyl group, or a substituted or unsubstituted aryl group, even more preferably from an unsubstituted acyl group, a substituted or unsubstituted alkyl group, or an unsubstituted aryl group.

In the case where the formula has two or more R¹¹'s, R¹²'s and R¹³'s, they may be the same or different.

p is an integer of 0 or more, and its preferred range is the same as the preferred range of the number of the hydroxyl groups per the monose unit to be mentioned below.

r is preferably a number larger than the number of the pyranose structural units or the furanose structural units contained in G.

q is preferably 0.

p+q+r is equal to the number of the hydroxyl groups on the presumption that G is an unsubstituted sugar group having a cyclic acetal structure, and therefore, the uppermost limit of these p, q and r is specifically defined depending on the structure of G.

Preferred examples of the substituent of the sugar ester compound include an alkyl group (preferably an alkyl group having from 1 to 22 carbon atoms, more preferably from 1 to 12 carbon atoms, even more preferably from 1 to 8 carbon atoms, for example, a methyl group, an ethyl group, a propyl group, a hydroxyethyl group a hydroxypropyl group, a 2-cyanoethyl group, a benzyl group), an aryl group (preferably an aryl group having from 6 to 24 carbon atoms, more preferably from 6 to 18 carbon atoms, even more preferably from 6 to 12 carbon atoms, for example, a phenyl group, a naphthyl group), an acyl group (preferably an acyl group having from 1 to 22 carbon atoms, more preferably from 2 to 12 carbon atoms, even more preferably from 2 to 8 carbon atoms, for example, an acetyl group, a propionyl group, a butyryl group, a pentanoyl group, a hexanoyl group, an octanoyl group, a benzoyl group, a toluoyl group, a phthalyl group), an amide group (preferably an amide group having from 1 to 22 carbon atoms, more preferably from 2 to 12 carbon atoms, even more preferably from 2 to 8 carbon atoms, for example, a formamide group, an acetamide group), an imide group (preferably an imide group having from 4 to 22 carbon atoms, more preferably from 4 to 12 carbon atoms, even more preferably from 4 to 8 carbon atoms, for example, a succinimide group, a phthalimide group). Of those, more preferred are an alkyl group and an acyl group; and even more preferred are a methyl group, an acetyl group and a benzoyl group; and especially preferred is a benzoyl group.

Preferably, the number of the hydroxyl groups per the structural unit in the sugar ester compound (this may be referred to as a hydroxyl group content below) is at most 3, more preferably at most 1. Controlling the hydroxyl group content to fall within the range is preferred since the sugar ester compound may be prevented from moving into the adjacent polarizing element layer to break the PVA-iodine complex therein while aged under high temperature and high humidity condition, and therefore the polarizing element performance may be prevented from worsening in aging under high temperature and high humidity condition.

The sugar ester compounds are available as commercial products such as Tokyo Chemical's Aldrich, etc., or may be produced according to known methods of converting commercially-available hydrocarbons into ester derivatives thereof (for example, according to the method described in JP-A 8-245678).

Preferably, the sugar ester compound has a number-average molecular weight of from 200 to 3500, more preferably from 200 to 3000, even more preferably from 250 to 2000.

Specific examples of the sugar ester compounds preferred for use in the invention are mentioned below; however, the invention is not limited to the following embodiments.

### Sugar Ester (1):

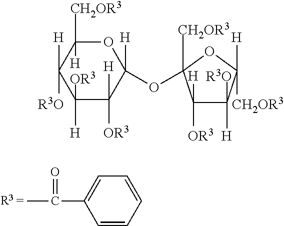

Sugar Ester (2) where Ac is an acetyl group:

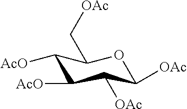

### Sugar Ester (3):

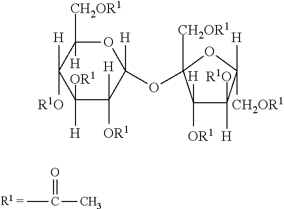

Sugar Ester (4) where Bz is a benzoyl group:

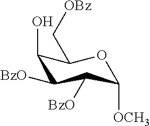

In the following structures, R each independently represents an arbitrary substituent, and two or more R's may be the same or different. C log P means a computed value of common logarithm log P of the partition coefficient P in 1-octanol and water. For computing C log P, used is the C LOG P program incorporated in Daylight Chemical Information Systems' System PC Models.

TABLE 1

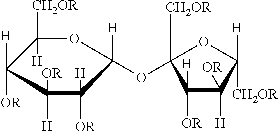

| | Substituent 1 | | Substituent 2 | | | |
|---|---|---|---|---|---|---|
| Com- | | Degree of | | Degree of | | Molecular |
| pound | Type | Substitution | Type | Substitution | ClogP | weight |
| 101 | Acetyl | 7 | Benzyl | 1 | 2.9 | 727 |
| 102 | Acetyl | 6 | Benzyl | 2 | 4.4 | 775 |
| 103 | Acetyl | 7 | Benzoyl | 1 | 3.0 | 741 |
| 104 | Acetyl | 6 | Benzoyl | 2 | 4.5 | 802 |
| 105 | Benzyl | 2 | None | 0 | 0.6 | 523 |
| 106 | Benzyl | 3 | None | 0 | 2.5 | 613 |
| 107 | Benzyl | 4 | None | 0 | 4.3 | 702 |
| 108 | Acetyl | 7 | Phenyl- | 1 | 2.7 | 771 |
| | | | acetyl | | | |
| 109 | Acetyl | 6 | Phenyl- | 2 | 4.4 | 847 |
| | | | acetyl | | | |

TABLE 2

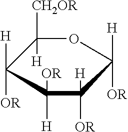

| | Substituent 1 | | Substituent 2 | | | |
|---|---|---|---|---|---|---|
| | | Degree of | | Degree of | | Molecular |
| Compound | Type | Substitution | Type | Substitution | ClogP | weight |
| 201 | Acetyl | 4 | Benzoyl | 1 | 2.2 | 468 |
| 202 | Acetyl | 3 | Benzoyl | 2 | 3.9 | 514 |
| 203 | Acetyl | 2 | Benzoyl | 3 | 5.4 | 577 |
| 204 | Acetyl | 4 | Benzyl | 1 | 2.1 | 454 |
| 205 | Acetyl | 3 | Benzyl | 2 | 3.8 | 489 |
| 206 | Acetyl | 2 | Benzyl | 3 | 5.4 | 535 |
| 207 | Acetyl | 4 | Phenylacetyl | 1 | 2.2 | 466 |
| 208 | Acetyl | 3 | Phenylacetyl | 2 | 3.8 | 543 |
| 209 | Acetyl | 2 | Phenylacetyl | 3 | 5.5 | 619 |
| 210 | Phenylacetyl | 1 | None | 0 | −0.3 | 298 |
| 211 | Phenylacetyl | 2 | None | 0 | 2.0 | 416 |
| 212 | Phenylacetyl | 3 | None | 0 | 3.8 | 535 |
| 213 | Phenylacetyl | 4 | None | 0 | 6.2 | 654 |

TABLE 3

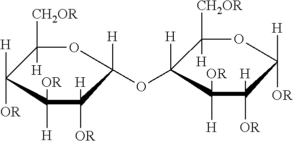

| | Substituent 1 | | Substituent 2 | | | |
|---|---|---|---|---|---|---|
| | | Degree of | | Degree of | | Molecular |
| Compound | Type | Substitution | Type | Substitution | ClogP | weight |
| 301 | Acetyl | 6 | Benzoyl | 2 | 4.5 | 803 |
| 302 | Acetyl | 6 | Benzyl | 2 | 4.2 | 775 |
| 303 | Acetyl | 6 | Phenylacetyl | 2 | 4.3 | 831 |
| 304 | Benzoyl | 2 | None | 0 | 0.2 | 551 |
| 305 | Benzyl | 2 | None | 0 | 0.0 | 522 |
| 306 | Phenylacetyl | 2 | None | 0 | 0.0 | 579 |

TABLE 4

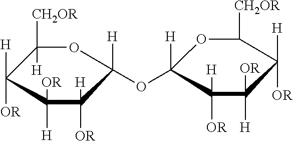

| | Substituent 1 | | Substituent 2 | | | |
|---|---|---|---|---|---|---|
| | | Degree of | | Degree of | | Molecular |
| Compound | Type | Substitution | Type | Substitution | ClogP | weight |
| 401 | Acetyl | 6 | Benzoyl | 2 | 4.5 | 803 |
| 402 | Acetyl | 6 | Benzyl | 2 | 4.2 | 775 |
| 403 | Acetyl | 6 | Phenylacetyl | 2 | 4.3 | 831 |
| 404 | Benzoyl | 2 | None | 0 | 0.7 | 551 |
| 405 | Benzyl | 2 | None | 0 | 0.4 | 523 |
| 406 | Phenylacetyl | 2 | None | 0 | 0.5 | 579 |

Preferably, the film of the invention contains the sugar ester compound in an amount of from 2 to 30% by mass relative to the cellulose acylate therein, more preferably from 5 to 20% by mass, even more preferably from 5 to 15% by mass.

In the case where the film contains the after-mentioned polyester-based plasticizer along with the sugar ester compound, the amount of the sugar ester compound (part by mass) relative to the amount of the polyester-based plasticizer (part by mass) is preferably from 2 to 10 times (ratio by mass), more preferably from 3 to 8 times (ratio by mass).

(2) Other plasticizer than sugar ester compound:

The film of the invention may contain any other plasticizer than the sugar ester compound.

Preferable examples of other plasticizers include: a phosphorus-containing plasticizer, a phthalate ester plasticizer, a trimellitate ester plasticizer, a pyromellitic ester plasticizer, a polyalcohol ester plasticizer, a gurikore-to ester plasticizer, a citrate ester plasticizer, a polyester plasticizer (such as a polyester plasticizer the end of which is a fatty-acid, a polyester plasticizer having aromatic ring), a carboxylate ester plasticizer and a acrylic polymer.

Among them, the film of the invention preferably includes both the sugar ester compound and the polyester plasticizer from the view point of increasing the contrast when the film of the invention is disposed in a liquid crystal display device.

As a plasticizer for use in the invention, the polyester plasticizer of which the number average molecular weight is 300 or more and less than 2,000 is preferably used from the view point of not arising the haze in the film or not bleeding out or evaporating from the film.

### (2-1) Polyester Plasticizer

The polyester plasticizer used for the present invention is not limited, preferably used is a polyester plasticizer having an aromatic ring or a cycloalkyl group.

For example, an aromatic terminal polyester plasticizer represented by the following formula (2) is preferably used:

B¹-(G¹-A¹)n-G¹-B¹ Formula (2)

wherein B¹ represents benzene monocarboxylic acid group residue, G¹ represents an alkylene glycol group residue having 2 to 12 carbon atoms, an aryl glycol group residue having 6 to 12 carbon atoms, or an oxyalkylene glycol group residue having 4 to 12 carbon atoms, A¹ represents an alkylene dicarboxylic acid residue having 4 to 12 carbon atoms, or an aryl dicarboxylic acid group residue having 6 to 12 carbon atoms, and n represents an integer of 1 or more.

A compound represented by the formula (2) is structured by benzene monocarboxylic acid group represented with B¹, an alkylene glycol group or an oxyalkylene glycol group or an aryl glycol group represented with G¹, and an alkylene dicarboxylic acid group or an aryl dicarboxylic acid group represented with A¹ and is prepared through a reaction similar to the preparation reaction of a common polyester plasticizer.

Examples of a benzene monocarboxylic acid component of the polyester plasticizer used for the present invention include: benzoic acid, p-tert-butyl benzoic acid, o-toluic acid, m-toluic acid, p-toluic acid, dimethyl benzoic acid, ethyl benzoic acid, n-propyl benzoic acid, aminobenzoic acid and acetoxy benzoic acid, which may be used alone or in combination of two or more acids.

Examples of an alkylene glycol component having 2 to 12 carbon atoms of the polyester plasticizer used for the present invention include: ethylene glycol, 1,2-propylene glycol, 1,3-propylene glycol, 1,2-butanediol, 1,3-butanediol, 2-methyl-1,3-propanediol, 1,4-butanediol, 1,5-pentanediol, 2,2-dimethyl-1,3-propanediol (also known as neopentylglycol), 2,2-diethyl-1,3-propanediol (also known as 3,3-dimethylol pentane), 2-n-butyl-2-ethyl-1,3-propanediol (also known as 3,3-dimethylol heptane), 3-methyl-1,5-pentanediol-1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, which may be used alone or in combination of two or more glycols.

The alkylene glycol component having 2 to 12 carbon atoms is preferably used as the compatibility with the cellulose acylate is high.

Examples of an oxyalkylene glycol component having 4 to 12 carbon atoms of the polyester plasticizer used in the present invention include: diethylene glycol, triethylene glycol, tetraethylene glycol, dipropylene glycol and triropylene glycol, which may be used alone or in combination of two or more glycols.

Examples of an alkylene dicarboxylic acid component having 4 to 12 carbon atoms having 4 to 12 carbon atoms of the polyester plasticizer used in the present invention include: succinic acid, maleic acid, the fumaric acid, glutaric acid, adipic acid, azelaic acid, sebacic acid and dodecane dicarboxylic acid, which may be used alone or in combination of two or more acids.

Examples of an arylene dicarboxylic acid component having 6 to 12 carbon atoms include: phthalic acid, terephthalic acid, isophthalic acid, 1,5-naphthalene dicarboxylic acid and 1,4-naphthalene dicarboxylic acid.

The number average molecular weight of the polyester plasticizer used for the present invention is preferably 300 to 1,500, and more preferably 400 to 1,000.

The acid value of the polyester plasticizer used in the present invention is preferably 0.5 mgKOH/g or less, more preferably 0.3 mgKOH/g or less. The hydroxyl value of the polyester plasticizer used in the present invention is preferably 25 mgKOH/g or less, more preferably 15 mgKOH/g or less.

The polycondensation of the polyester plasticizer is carried out by a usual method. The polyester can be easily synthesized by, for example, (i) a direct reaction of the dibasic acid with the glycol, a thermal melt condensation method by a esterification reaction or an ester interchanging reaction of the above dibasic acid or an alkyl ester thereof such as a methyl ester with the glycol, or (ii) a dehydrohalogenation reaction of an acid chloride of the dibasic acid with the glycol.

The direct reaction is preferably applied for preparing the polyester having a relatively small weight average molecular weight.

The polyester plasticizer having high frequency of molecular weight on the lower molecular weight side shows considerably high compatibility with the cellulose acylate and cellulose ester film having low moisture permeability and high transparency can be obtained after formation of the film.

The method for controlling the molecular weight is not specifically limited and usual methods can be applied. For example, the molecular weight can be controlled by adding amount of a mono-valent acid or a mono-valent alcohol in a method for blocking the molecular terminal by the mono-valent acid or the mono-valent alcohol in accordance with the polymerization condition.

In such the case, the control by the mono-valent acid is preferable for the stability of the polymer. As examples of such the acid, acetic acid, propionic acid, butylic acid, pivalic acid and benzoic acid can be cited. One of such the acid is selected, which is difficulty distilled out to the reaction system during the polymerization reaction and easily distilled out at the time for removing the mono-valent acid after stopping the polymerization reaction. These acids may be used in mix.

In the case of the direct reaction, the number average molecular weight can be controlled by deciding the time for stopping the reaction according to the amount of water distilled out in the course of reaction. The control of the number average molecular weight can be also carried out by biasing the mole number of the glycol or the dibasic acid or by controlling the reaction temperature.

The molecular weight of the polyester plasticizer used in the present invention can be measured using the measuring method by the above-mentioned GPC or by an end group determination method (measuring method for the hydroxyl value).

The amount of the polyester plasticizer in the cellulose acylate film is preferably from 1 to 40% by weight with respect to the cellulose acylate, particularly preferably from 5 to 15% by weight.

Examples of the polyester plasticizer preferably used in the present invention are shown below;

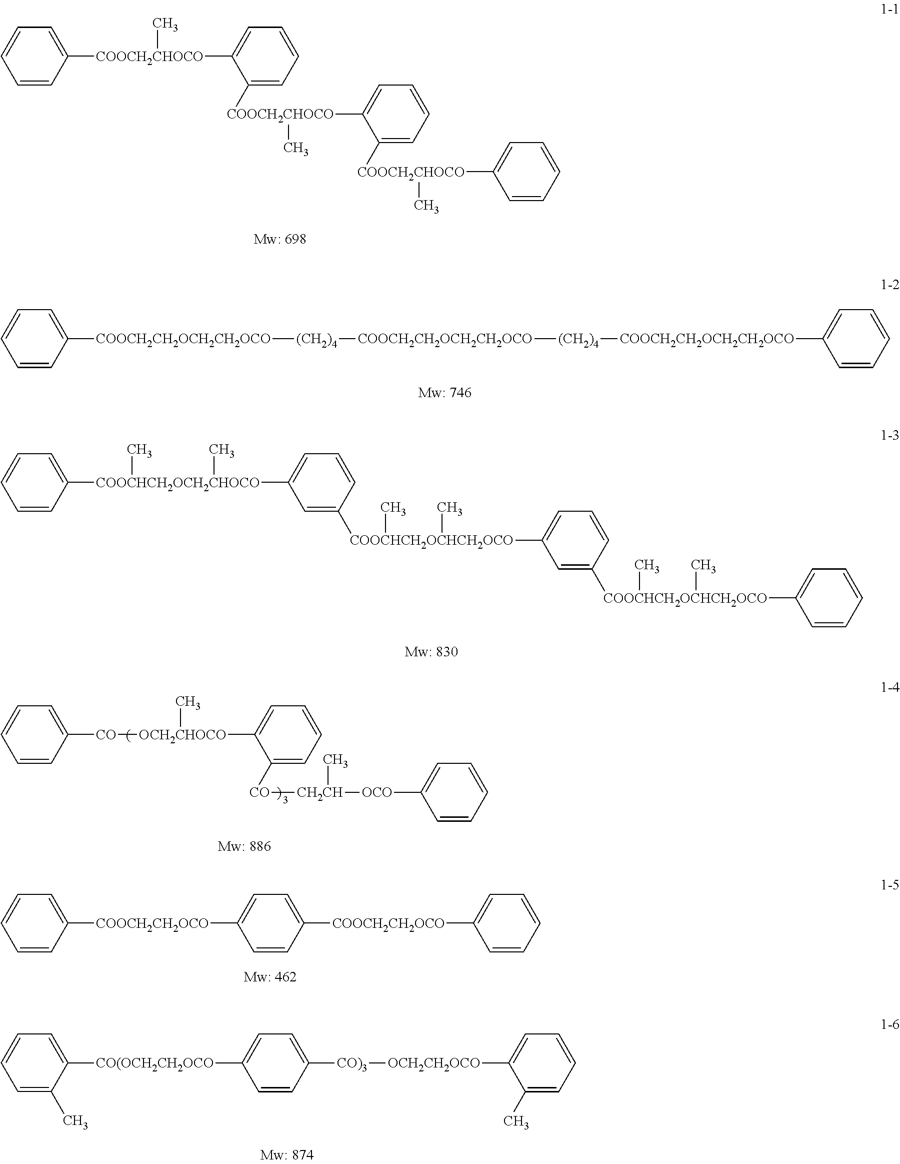

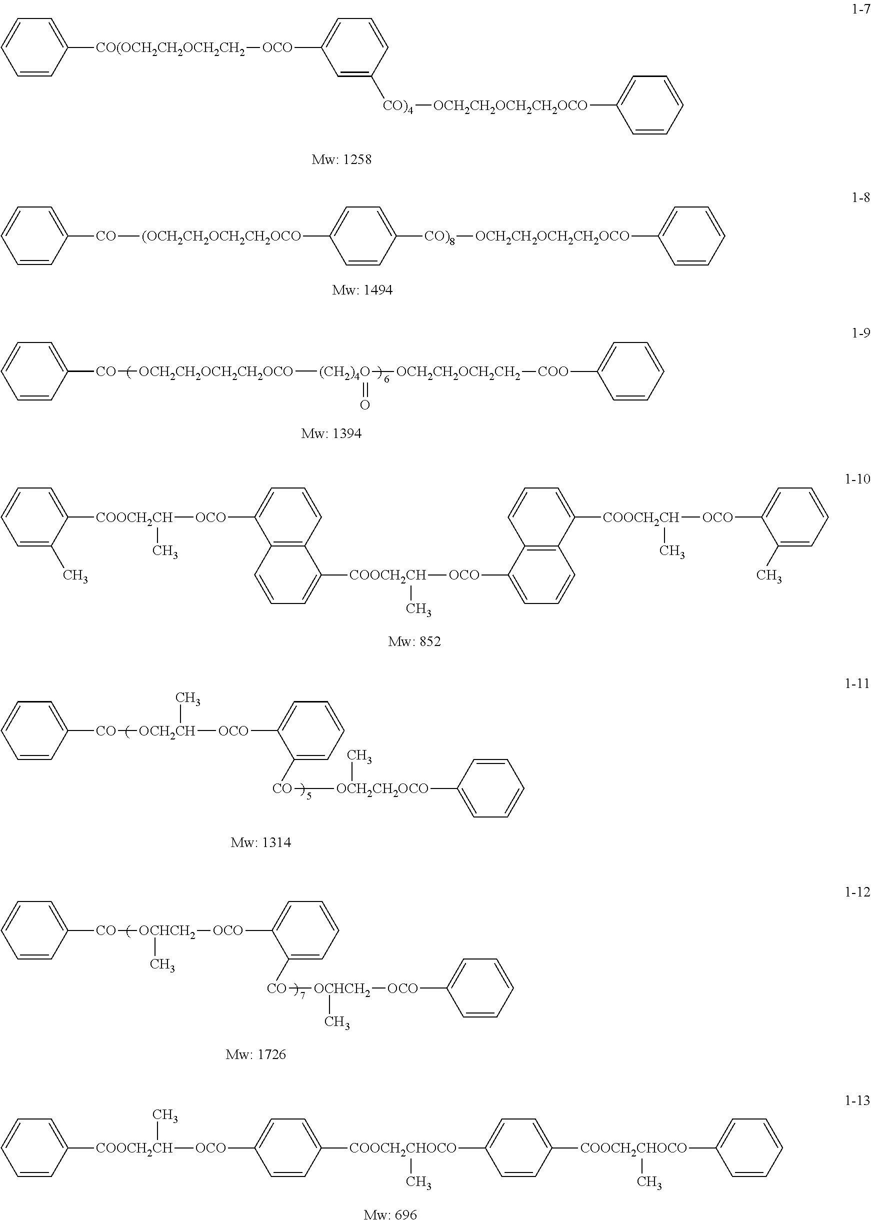

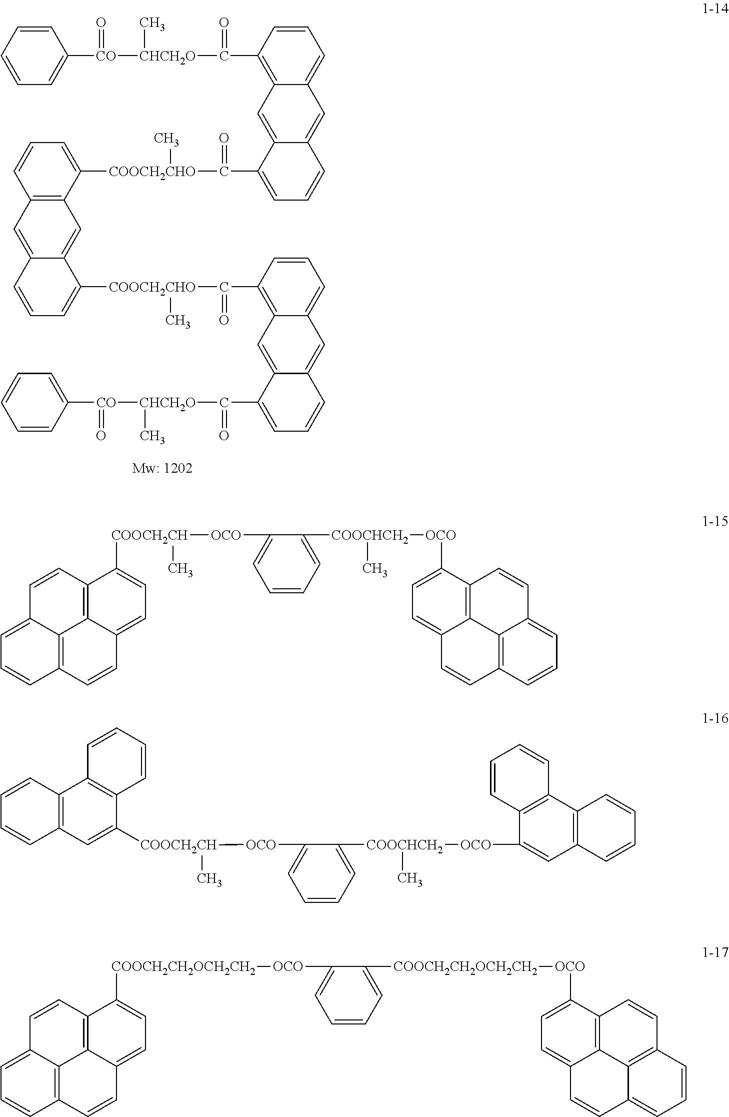

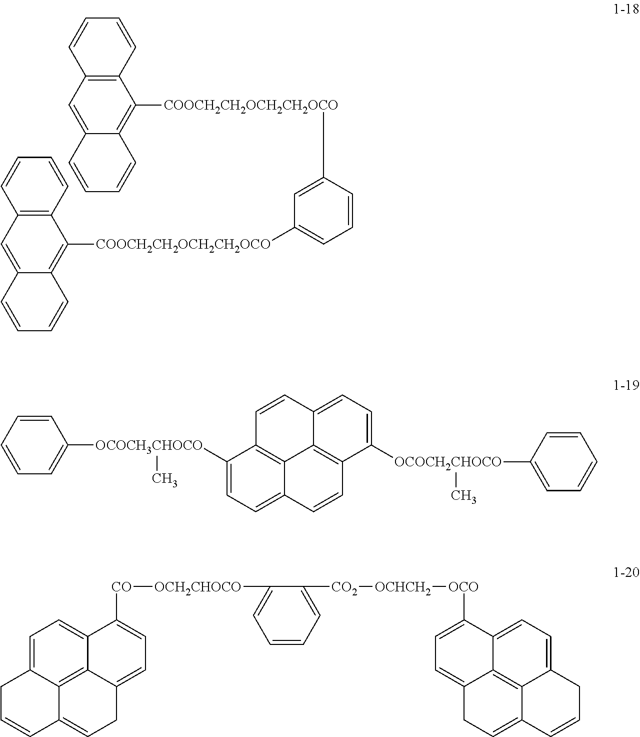

### (2-2) Polyalcohol Ester Plasticizer

The polyalcohol ester used as a plasticizer in the present invention is an ester prepared from a monocarboxylic acid and an aliphatic polyalcohol having a valence of 2 or more. It preferably contains an aromatic ring or a cycloalkyl ring in the molecule.

The polyalcohol used in the present invention is represented by the following formula (3):

R²¹—(OH)n Formula (3)

Wherein R²¹ represents an organic acid having a valence of n, n represents a positive integer of 2 or more.

Examples of a preferable polyalcohol are listed below, however, the present invention is not limited thereto: adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, pentaerythritol and dipentaerythritol. Specifically, trimethylolpropane and pentaerythritol are preferable.

A mono carboxylic acid to be used for the polyalcohol ester is not specifically limited, and well known compounds such as aliphatic monocarboxylic acid, alicyclic monocarboxylic acid and aromatic monocarboxylic acid may be used.

Alicyclic monocarboxylic acid or aromatic monocarboxylic acid is preferably used with respect to improving moisture permeability and retention of additives. Examples of preferable monocarboxylic acids are listed below, however, the present invention is not limited thereto.

For aliphatic monocarboxylic acids, normal or branched fatty acids having from 1 to 32 carbon atoms are preferably used. The number of carbon atoms is more preferably from 1 to 20 and still more preferably from 1 to 10.

The use of an acetic acid will help improve the mutual solubility, so that a mixture of an acetic acid and other monocarboxylic acids is also preferable.

Examples of preferable aliphatic mono carboxylic acids include saturated fatty acids such as: acetic acid, propionic acid, butyric acid, valeric acid, caproic acid, enanthic acid, caprylic acid, pelargonic acid, capric acid, 2-ethyl-hexanoic acid, undecylic acid, lauric acid, tridecylic acid, myristic acid, pentadecylic acid, palmitic acid, heptadecanoic acid, stearic acid, nonadecane acid, arachidic acid, behenic acid, lignoceric acid, cerotinic acid, heptacosanoic acid, montanic acid, melissic acid, lacceric acid, as well as unsaturated fatty acids such as: undecylic acid, oleic acid, sorbic acid, linoleic acid, linolenic acid and arachidonic acid.

Examples of preferable alicyclic monocarboxylic acids include: cyclopentanecarboxylic acid, cyclohexanecarboxylic acid, cyclooctanecarboxylic acid, and derivatives thereof.

Examples of preferable aromatic monocarboxylic acids include: benzoic acid and toluic acid, both of which have benzene ring in which alkyl groups are introduced, biphenylcarboxylic acid, naphthalenecarboxylic and tetralincarboxylic acid having 2 or more benzene rings, and derivatives thereof, of these, benzoic acid is specifically preferred.

The molecular weight of the polyalcohol ester is preferably from 300 to 1,500 and more preferably from 350 to 750. A higher molecular weight is preferable in that the volatility of the polyalcohol is reduced, while a lower molecular weight is preferable with respect to moisture permeability, or to mutual solubility with cellulose ester.

To be used for a polyalcohol ester, carboxylic acid may be used alone or in combination of two or more carboxylic acids. Hydroxyl groups in a polyalcohol may be completely esterified or partially esterified remaining unsubstituted hydroxyl groups. Specific examples of polyalcohol esters are shown below:

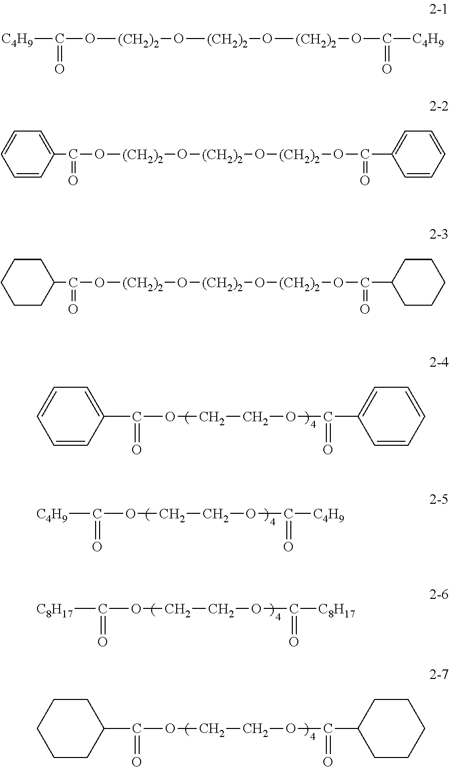

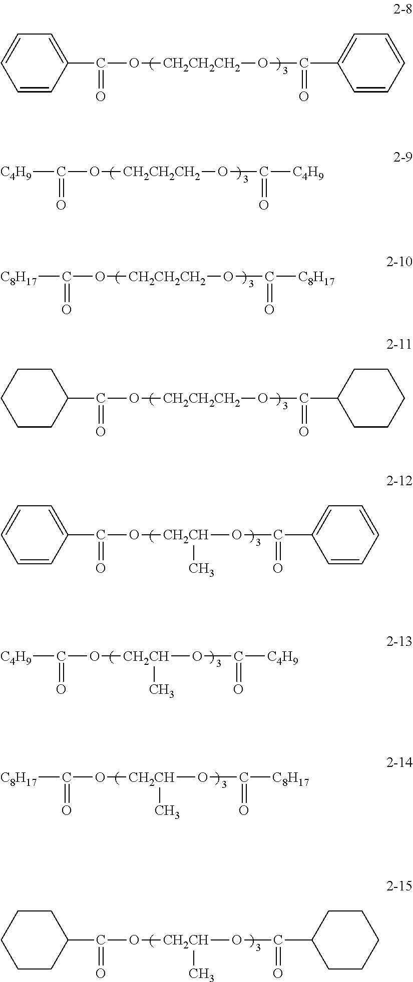

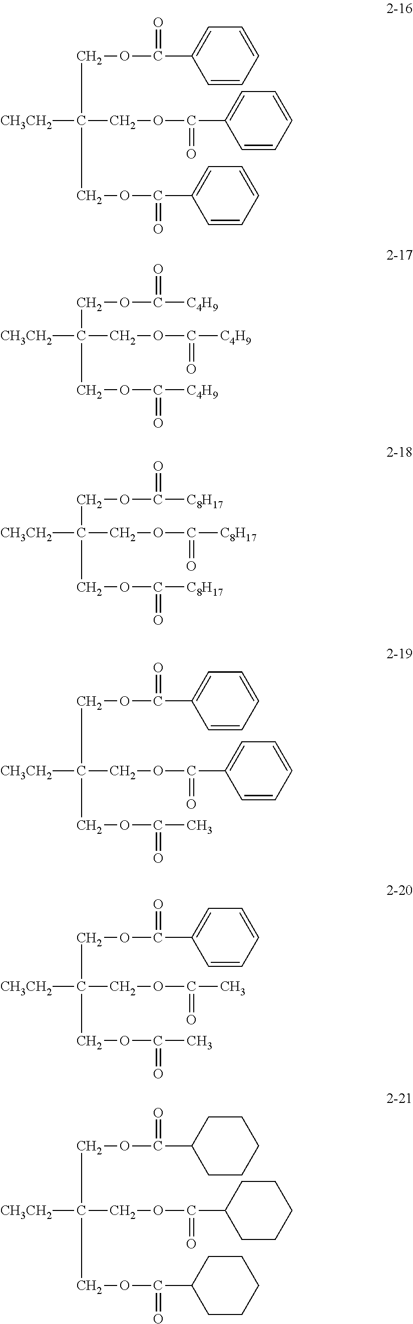

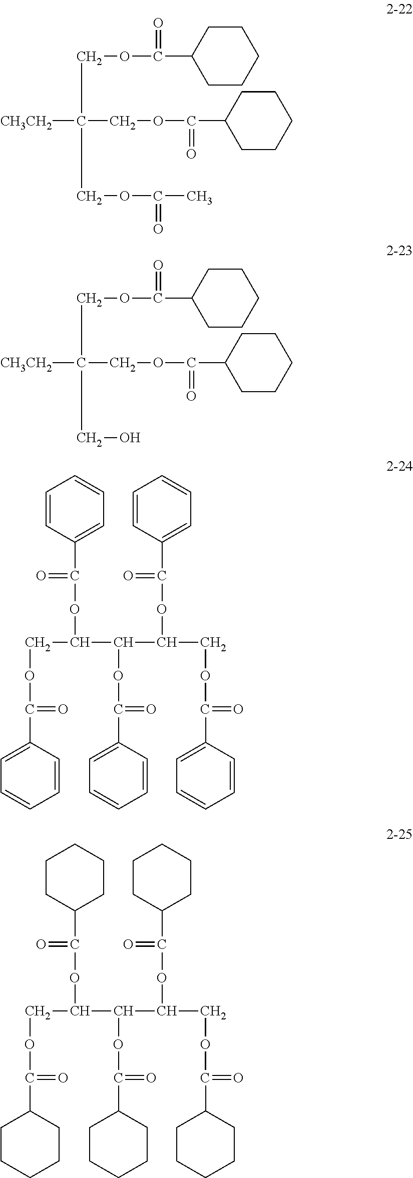

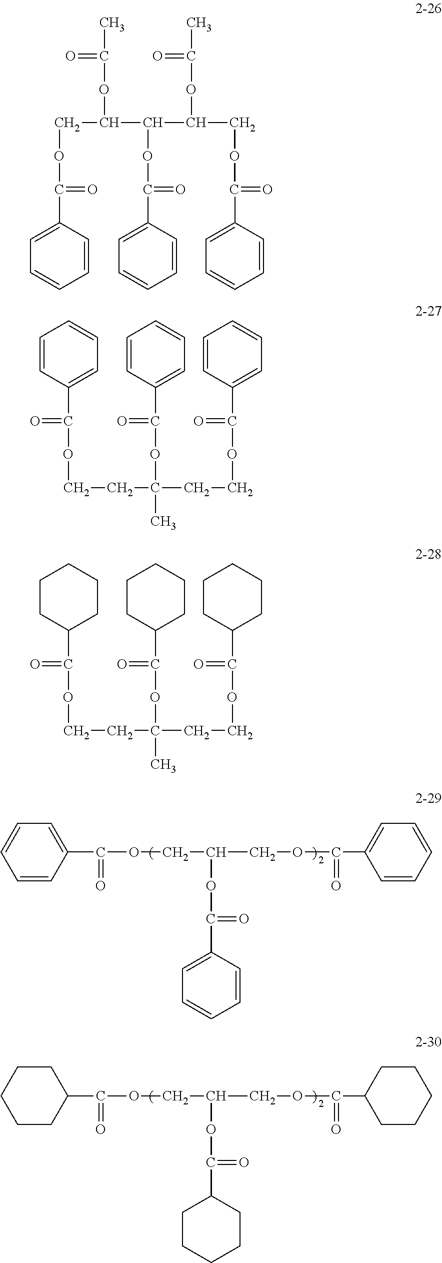

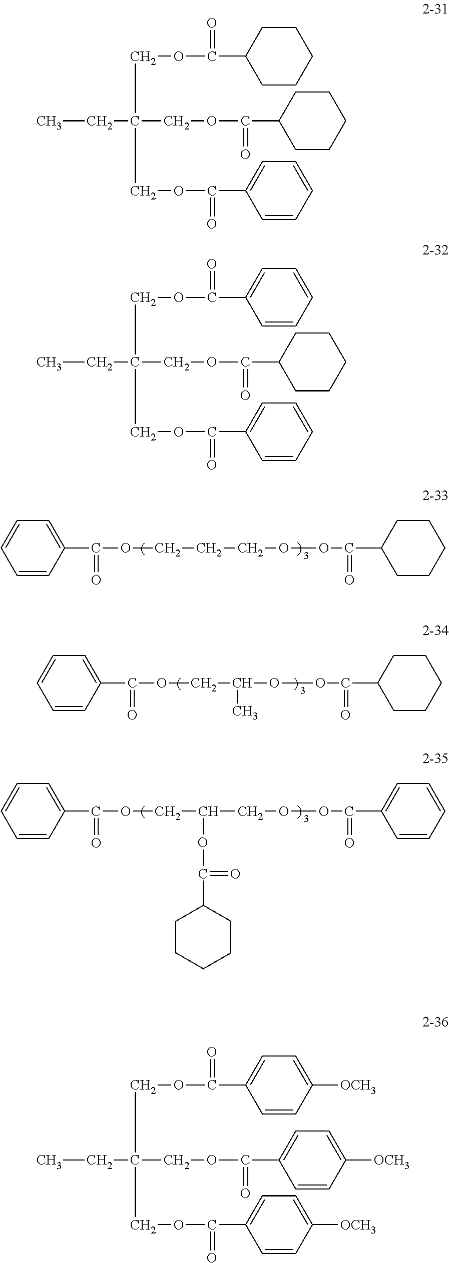

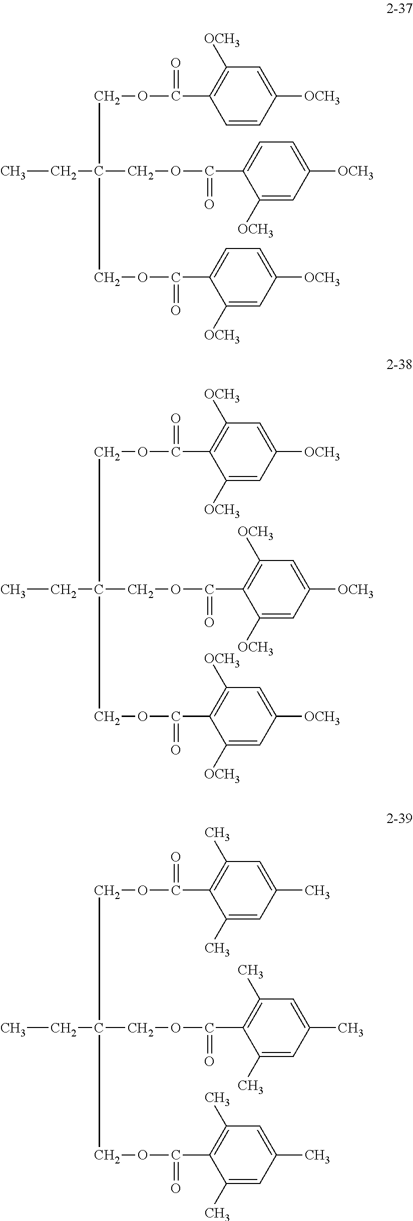

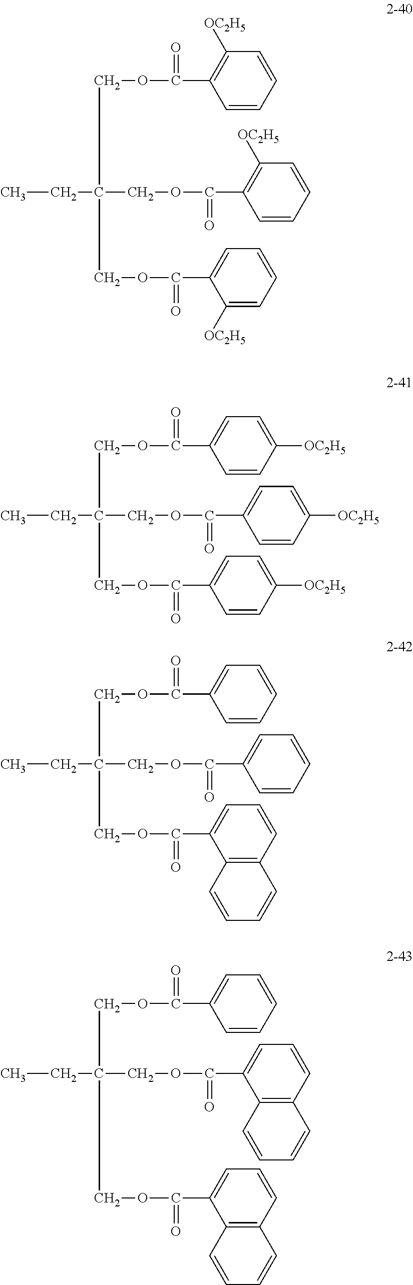

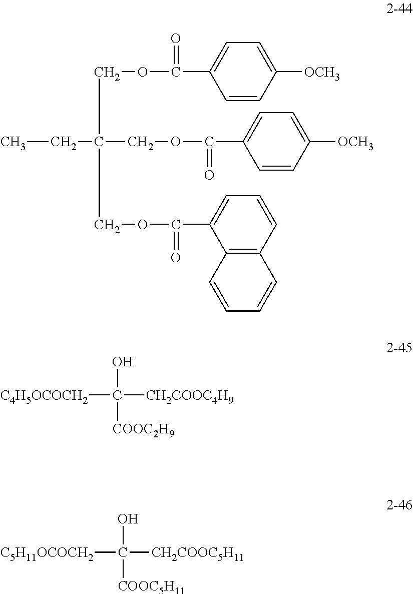

The content of the polyalcohol ester in the cellulose acylate film is preferably from 1 to 15% by weight, particularly preferably from 3 to 10% by weight.

### (3) Retardation Enhancer

The film of the invention may contain a retardation enhancer. Containing a retardation enhancer, the film can exhibit high Re expressibility even though stretched at a low draw ratio. The type of the retardation enhancer is not specifically defined. The retardation enhancer includes rod-shaped or discotic compounds, and the above-mentioned non-phosphate compounds having the ability to enhance retardation. Rod-shaped or discotic compounds having at least two aromatic rings are preferred as the retardation enhancer for use herein.

Two or more different types of retardation enhancers may be used here as combined.

Preferably, the retardation enhancer has a maximum absorption in a wavelength region of from 250 to 400 nm, more preferably substantially not having an absorption in a visible region.

As the retardation enhancer, for example, usable are the compounds described in JP-A 2004-50516 and 2007-86748, to which, however, the invention is not limited.

As the discotic compound for use herein, for example, preferred are the compounds described in EP 0911656-A2, the triazine compounds described in JP-A 2003-344655, and the triphenylene compounds described in JP-A 2008-150592, paragraphs [0097] to [0108].

The discotic compounds usable herein may be produced according to known methods, for example, according to the method described in JP-A 2003-344655, the method described in JP-A 2005-134884, etc.

In addition to the above-mentioned discotic compounds, also preferred for use herein are rod-shaped compounds having a linear molecular structure; and for example, the rod compounds described in JP-A 2008-150592, paragraphs [0110] to [0127] are preferred.

### (4) Acrylic Polymer:

An acrylic polymer having a weight-average molecular weight of from 500 to 10,000 may be further added to the cellulose acylate film of the invention. Preferably, the acrylic polymer has a weight-average molecular weight of from 500 to 5,000.

Containing such an acrylic polymer, the formed cellulose acylate film may have excellent transparency and may have an extremely low degree of moisture permeability, and therefore the film may exhibit excellent characteristics as a polarizer protective film. As the acrylic polymer, preferred for use herein are the compounds described in WO2008-126535.

### (5) Antioxidant, Thermal Degradation Inhibitor:

As an antioxidant and a thermal degradation inhibitor, any known ones are usable in the invention. In particular, preferred are lactone compounds, sulfur compounds, phenolic compounds, double bond-containing compounds, hindered amines, phosphorus compounds. As the antioxidant and the thermal degradation inhibitor for use herein, preferred are the compounds described in WO2008-126535.

### (6) Colorant:

The film of the invention may contain a colorant. Colorant generally include dye and pigment; but in the invention, the colorant is meant to indicate a substance having an effect of making the liquid crystal panel have a bluish tone, or an effect of controlling the yellow index of the panel or reducing the haze thereof. As the colorant, preferred for use herein are the compounds described in WO2008-126535.

### (7) Other Additives:

Other additives generally used in ordinary cellulose acylate film may be added to the cellulose acylate film of the invention.

The additives include, for example, UV absorbent, fine particles, etc.

As those other additives, preferred for use herein are the substances described in WO2008-126535.

Examples of fine particles for use in the invention include, for example, an inorganic compound such as: silicon dioxide, titanium dioxide, aluminum oxide, zirconium oxide, calcium carbonate, talc, clay, calcined kaolin, calcined calcium silicate, calcium silicate hydrate, aluminum silicate, magnesium silicate and calcium phosphate.

Fine particles containing silicon are preferred because the haze of the film becomes low, and silicon dioxide is particularly preferred.

A primary average particle size of the fine particles is preferably 5 to 50 nm, more preferably 7 to 20 nm. These fine particles are preferably included in the film of the invention as secondary aggregates having 0.05 to 0.3 μm particle size.

The content of these fine particles in the cellulose acylate film is preferably 0.05 to 1% by mass, particularly preferably 0.1 to 0.5% by mass. The surface layer preferably includes the fine particle as in the above amount when the film is formed by co-casting method to form a multilayered film.

As fine particles of silicon dioxide, marketed productions can be used, including, for example, AEROSIL R972, R972V, R974, R812, 200, 200V, 300, R202, OX50, TT600 and NAX50 (all of them are manufactured by NIPPON AEROSIL CO., LTD.) etc.

As fine particles of zirconium oxide, for example, those available in the market under trade names of AEROSIL R976 and R811 (manufactured by NIPPON AEROSIL CO., LTD.) can be used.

Examples of polymer fine particles, for example, include a silicone resin, a fluorine resin and an acrylic resin. The silicone resin is preferable and the silicone resin having 3 dimensional network structure is particularly preferable, for example, those available in the market under trade names of Tospearl 103, 105, 108, 120, 145, 3120 and 240 (manufactured by Toshiba Silicones) can be used.

Among these, AEROSIL 200V and AEROSIL R972V are particularly preferred, because they show exert a large effect of lowering a friction coefficient while maintaining the haze of an optical film at a low level.

### [Method for Producing Cellulose Acylate Film]

The method for producing a cellulose acylate film of the invention (which refers as “the method for producing film of the invention” below) comprises stretching a film that contains a cellulose acylate and a sugar ester compound having from 1 to 12 pyranose structures or furanose structures where at least one hydroxyl group is esterified, at (Tg−5° C.) to (Tg+10° C.) while as yet the film is not heated at all at (Tg−5° C.) or higher.

The production method of the invention is described below.

The production method for the optical film of the invention comprises formation of the above-mentioned cellulose acylate-containing film according to a solution casting method or a melt casting method. From the viewpoint of bettering the film surface condition, the production method for the optical film of the invention preferably comprises forming the cellulose acylate-containing film in a mode of solution casting film formation.

The production method for the optical film of the invention is described below with reference to an embodiment of solution casting film formation; however, the invention is not limited to the mode of solution casting film formation. In the case where the optical film of the invention is produced according to a melt casting method, any known method is employable.

### (Polymer Solution)

In the solution casting film formation method, a polymer solution containing cellulose acylate and necessary various additives (cellulose acylate solution) is formed into a web. The polymer solution for use in the solution casting film formation method (this may be referred to as cellulose acylate solution below) is described below.

### (Solvent)

The cellulose acylate used in the invention are dissolved in a solvent to obtain a dope. The solvent is preferably volatile since the solvent is necessary to be evaporated after casting or extruding the dope on a support to form a film on the support.

Further, the solvent is a solvent, which does not react with the metal compound or catalyst used and which does not dissolve a support on which a dope containing the solvent is cast or extruded. The solvent may be used as a mixture of two or more kinds thereof.

The organic polymer in the invention and the reactive metal compound in the invention may be dissolved in a different solvent, separately, and then the resulting solutions may be mixed.

In the invention, an organic solvent capable of dissolving the cellulose derivative described above is referred to as a good solvent, and an organic solvent used in a large amount to dissolve the cellulose derivative is referred to as a main organic solvent.

Examples of the good solvent include ketones such as acetone, methyl ethyl ketone, cyclopentanone and cyclohexanone; ethers such as tetrahydrofuran (THF), 1,4-dioxane, 1,3-dioxolane and 1,2-dimethoxyethane; esters such as methyl formate, ethyl formate, methyl acetate, ethyl acetate, amyl acetate and γ-butyrolactone; methylcellosolve; dimethylimidazolinone; dimethylformamide; dimethylacetoamide; acetonitrile; dimethylsulfoxide; sulfolane; nitroethane; methylene chloride; and methyl acetoacetate. 1,3-dioxolane, THF, methyl ethyl ketone, acetone, methyl acetate and methylene chloride are preferred.

The dope used in the invention preferably contains an alcohol having 1 to 4 carbon atoms in an amount of not less than 1 to 40% by weight, in addition to the solvents described above.

When a dope employing such an alcohol is cast on a metal support, and the solvent is evaporated to form a web (referred to a dope film formed on a support after the cellulose acylate dope is cast on the support), the residual alcohol content of the web increases during solvent evaporation, and the residual alcohol as a gelling agent results in gelation of the web, whereby the web formed are easily peeled from the support. An organic solvent containing such an alcohol in a small amount increases solubility of a cellulose acylate in an organic solvent containing no chlorine atom, and restrains gelation or separation of the reactive metal compound or viscosity increase of the dope.

The alcohols having 1 to 4 carbon atoms include methanol, ethanol, n-propanol, iso-propanol, n-butanol, sec-butanol, tert-butanol and propylene glycol monomethyl ether.

Of these alcohol solvents, ethanol is preferred, which provides good dope stability, has a relatively low boiling point and good drying property and is less harmful. These alcohol solvents alone cannot dissolve the cellulose derivative and therefore belong to poor solvents.

As the cellulose acylate constituting the cellulose acylate film of the invention contains a hydrogen-bonding functional group such as a hydroxyl group, an ester or a ketone, the alcohol is contained preferably in an amount of 5 to 30% by mass, more preferably in an amount of 7 to 25% by mass, and still more preferably in an amount of 10 to 20% by mass, in all solvents, from the viewpoint of a reduction in peeling load from a casting support.

The adjustment of the alcohol content can make it easy to control the development of Re or Rth of the cellulose acylate film produced by the production method of cellulose acylate film of the invention. Specifically, further development of Re or Rth of the cellulose acylate film becomes possible to more increase the arriving range of Re or Rth by increasing the alcohol content or to set the heat treatment temperature relatively low.

Further, in the invention, it is also effective for an increase in solution viscosity or in film strength in a wet film state at the time of drying, or an increase in dope strength at the time of casting by a drum method to allow water to be contained in small amounts. For example, water may be allowed to be contained in an amount of 0.1 to 5% by mass, more preferably in an amount of 0.1 to 3% by mass, and particularly in an amount of 0.2 to 2% by mass, based on the whole solution.

Examples of the combination of the organic solvents preferably used in the present invention are described in JP-A 2009-26551.

Further, the case where non-halogen-based organic solvents are used as the main solvents is described in detail in JIII Journal of Technical Disclosure (No. 2001-1745, published on Mar. 15, 2001, Japan Institute of Invention and Innovation), and can be appropriately used.

The cellulose acylate concentration in the above-mentioned polymer solution to be prepared is preferably from 5 to 40% by mass, more preferably from 10 to 30% by mass, and most preferably from 15 to 30% by mass.

The above-mentioned cellulose acylate concentration can be adjusted to a predetermined concentration at a stage in which the cellulose acylate is dissolved in the solvent. Further, after a solution having a low concentration (for example, 4 to 14% by mass) is previously prepared, it may be concentrated by evaporating the solvent, or the like. Furthermore, after a solution having a high concentration is previously prepared, it may be diluted. In addition, the polymer concentration can also be decreased by adding an additive.

The timing to add an additive can be suitably determined according to the kind of the additive.

Of the solvents satisfying the conditions described above and dissolving the cellulose acylate as a preferred organic polymer, the preferred are a mixture solvent of methylene chloride and ethyl alcohol (having a methylene chloride to ethyl alcohol ratio of from 95:5 to 80:20), and a mixture solvent of methyl acetate and ethyl alcohol (having a methyl acetate to ethyl alcohol ratio of from 60:40 to 95:5).

### (1) Step of Dissolving

The step of dissolving is a step preparing the dope by dissolving the above cellulose acylate and an additive in an organic solvent under stirring in a reactor or by adding a solution of at least one additive to a solution of the above cellulose acylate.

Specific examples of these methods include methods carrying out the dissolution at an ordinary pressure, methods carrying out the dissolution at a temperature of equal to or lower than the boiling point of the major solvent, methods carrying out the dissolution at a temperature of equal to or higher than the boiling point of the major solvent under application of pressure, methods using a means of cooling dissolution described in JP-A 9-95544, JP-A 9-95557 and JP-A 9-95538, and methods applying extra-high pressure described in JP-A 11-21379. Especially, methods carrying out the dissolution at a temperature of equal to or higher than the boiling point of the major solvent under application of pressure are preferable.

The concentration of the cellulose acylate in the dope is preferably from 10 to 35% by mass.

After the additives may be added to the cellulose during dissolving dope or after dissolved dope and then dispersed, the dope is filtrated by filtration materials, degassed and fed to the next step via a pump.

### (2) Step of Casting

The step of casting is a step which the dope is fed to a pressure type die via a pump (for example, pressure type metering gear pump); and the dope is cast on a metal support of an endlessly running metal-belt having no edge such as a stainless belt or rotating metal-drum at a predetermined position via a pressured die-slit.

A pressure-type die the slit-shape of the die-cap portion of which can be adjusted and the thickness of the film can be adjusted to the desired range easily is preferable. Examples of the pressure-type die include a hanger coat die and a T-die, and are preferable used. The metal supports having a mirror-finished surface are preferable. For improving the film-forming rate, two or more pressure-type dies may be disposed on the support, and the divided dope may be cast on the support in the multilayered manner. Or it is preferable that two or more dopes are co-cast on the support at the same time to give a multilayered film.

### (3) Step of Evaporating Solvent

The step of evaporating solvent is a step which the web (a dope film in the state before becoming final products of a cellulose acylate film, and still contains many solvents is referred to as “web”) is dried on the metal support, and the solvent is evaporated from the web so that the web can be peeled off from the support.

In order to evaporate the solvent, applying a wind to the web from the web side, heating the web by liquid at the rear side, and/or heating the web at both sides with radiation heat may be carried out; and heating the web by liquid at the rear side is preferable from the view point of good drying efficiency. These methods may be carried out singly or in combination with other(s). In the case where the heating the web by liquid at the rear side is used, it is preferable to heat lower than the boiling point of the used main solvent or an organic solvent having lowest boiling point.

### (4) Step of Peeling

The peeling step is the step of peeling the web, from which the solvent is evaporated, from the metal support at the peeling-position. The web peeled from the support may be fed into the next step. If the amount of the residual solvent, which is calculated according to the following formula, is much high, it may be difficult to peel the web from the support; on the other hand, if the amount of the residual solvent is much small, the web may separate from the support in midstream.

One example of the method for improving the film-forming rate is a gel casting method. The peeling step can be carried out for the web having as much as possible amount of the residual solvent, which can improve the film-forming rate. For example, the dope containing a poor solvent may be turned into a gel after being cast; or the dope may be turned into a gel by lowering the temperature of the metal support. If the dope is turned into a gel on the support, the film-strength may be improved, which makes it possible to carry out the peeling step earlier and therefore, improves the film-forming rate.

The amount of the residual solvent in the web on the metal support may be suitably decided according to the drying condition or the length of the metal support; and usually, the amount of the residual solvent in the web when being peeled from the support is from 5 to 150% by mass. If the web is peeled from the support at the point having higher amount of the residual solvent, the amount of the residual solvent in the web when being peeled from the support may be decided in a balance between the film-forming rate and the quality. In the invention, the temperature of the web at the point being peeled from the support is preferably from −50 to 40° C., more preferably from 10 to 40° C. and most preferably from 15 to 30° C.

And the amount of the residual solvent in the web when being peeled from the support is preferably from 10 to 150% by mass, more preferably from 10 to 120% by mass.

The amount of the residual solvent in the web is defined as follows.

The amount of the residual solvent (% by mass)={(M−N)/N}×100

M represents the mass of a web at any point; and N represents the mass of the web after being dried at 110° C. for three hours.

### (5) Steps of Drying or Heat Treatment and Stretching

In the method for producing of the present invention, the cellulose acylate film is stretched and a temperature during stretching is from Tg−5° C. to Tg+10° C. in the state which the film has never heated over Tg−5° C. before the stretching.

After the peeling step, the web may be dried through a drying apparatus employing two or more rolls which feed a web alternately and/or through a tenter apparatus employing clips which feed a web by grasping both ends of the web.

In the production method of the invention, the web may be heat-treated before stretching it, or may not be heat-treated. In the case where the web is heat-treated, the invention is characterized in that the web is not heated at all at Tg−5° C. or higher, where Tg means the glass transition temperature of the cellulose acylate film.

According to WO2008-126535, the film capable of increasing the contrast of a liquid crystal display device into which the film is incorporated is produced by heating, before it is stretched, the cellulose acylate film at a temperature higher than the stretching temperature thereof. In particular, heretofore, the film is heated at a temperature higher by at least 20° C. than the stretching temperature. In the case where the film production method includes the heating step that is normally unnecessary for stretching the film for making the film exhibit retardation, the fuel cost remarkably increases and the method separately requires the heating means or apparatus in addition to the stretching apparatus. Accordingly, the existing films capable of increasing display contrast are unsatisfactory from the viewpoint of the production cost, and therefore it is desired to lower the heat treatment temperature to thereby significantly reduce the production cost. However, the present inventors have found that, when the heat treatment temperature for the film described in Examples in WO2008-126535 is lowered, the front contrast of the display device comprising the film thus produced is remarkably lowered. Accordingly, for the existing films intended for display contrast elevation, the production cost could not be reduced any more in view of the production process for the film.

According to the invention in which a sugar ester compound is added to cellulose acylate and formed into a film, the total haze and the internal haze of the film may be made to fall within the range of the invention by stretching the film at the specific temperature to be mentioned below even though the film is not stretched at all at Tg−5° C. before it is stretched. The production cost of the film of the invention is lower than before, but when incorporated in a liquid crystal display device, the film can increase the display contrast.

In the case where the film is heat-treated in the invention, the heat treatment temperature is lower than Tg−5° C., preferably from Tg−20° C. to lower than Tg−5° C., even more preferably from Tg−15° C. to lower than Tg−5° C.

The heat treatment time is preferably at most 30 minutes, more preferably at most 20 minutes, even more preferably 10 minutes or so.

The means for drying the web are usually means of applying hot wind to the web; and microwaves may be applied to the web in place of hot wind. The preferable temperature, amount of wind and time for drying may be varied depending on the solvent to be used; and the conditions for drying may be defined depending on the types or the combinations of the solvent to be used.

In the production method of the invention, the film may be stretched in any direction of the film transferring direction (referred to as machine direction below) or in the direction perpendicular to the film transferring direction (referred to as lateral direction below), but is preferably stretched in the direction perpendicular to the film transferring direction from the viewpoint of making the film express the desired retardation. More preferably, the film is stretched biaxially both in the machine direction and in the lateral direction. The stretching may be attained in one stage or in multiple stages.

Preferably, the draw ratio in stretching the film in the film transferring direction is from 0 to 20%, more preferably from 0 to 15%, even more preferably from 0 to 10%. The draw ratio (elongation) in stretching the cellulose acylate web may be attained by the peripheral speed difference between the metal support speed and the peeling speed (peel roll draw). For example, in the case where an apparatus having two nip rolls is used, the rotation speed of the nip roll on the outlet side is made faster than that of the nip roll on the inlet side, whereby the cellulose acylate film may be stretched preferably in the transferring direction (machine direction). The stretching may control the retardation expressibility of the film.

“Draw ratio (%)” as referred to herein is computed according to the following formula:

Draw Ratio (%)=100×{(length after stretching)−(length before stretching)}/(length before stretching).

The draw ratio in stretching the film in the direction perpendicular to the film transferring direction is preferably from 0 to 50%, more preferably from 10 to 50%, even more preferably from 20 to 40%.

In the method of stretching the film in the direction perpendicular to the film transferring direction in the invention, preferably used is a tenter apparatus.

In biaxially stretching the film, for example, the film may be relaxed by from 0.8 to 1.0 time in the machine direction to thereby make the film have the desired retardation. The draw ratio in stretching may be defined depending on the intended optical properties of the film. In producing the cellulose acylate film of the invention, the film may be monoaxially stretched in the machine direction.

In the production method of the invention, the temperature in stretching is from Tg−5° C. to Tg+10°, preferably from Tg−5° C. to Tg+5° C., more preferably from Tg−5° C. to Tg+3° C. Stretching the film at a temperature falling within the range is preferred as reducing the total haze and the internal haze of the film of the invention.

After the stretching step, the film may be dried. In the case where the film is dried after the stretching step, the drying temperature, the drying air level and the drying time vary depending on the solvent used; and therefore the drying condition may be determined depending on the type and the combination of the solvents used. In the invention, the drying temperature after the stretching step is preferably lower than the stretching temperature in the stretching step, from the viewpoint of increasing the front contrast of the liquid crystal display device in which the film is incorporated.

### (6) Winding:

The length of the cellulose acylate film thus produced in the manner as above is preferably wound up into a roll having a length of from 100 to 1000 m, more preferably from 500 to 7000 m, even more preferably from 1000 to 6000 m. The width of the film is preferably from 0.5 to 5.0 m, more preferably from 1.0 to 3.0 m, even more preferably from 1.0 to 2.5 m. In winding up the film, preferably, the film is knurled at least on one side thereof, and the knurling width is preferably from 3 mm to 50 mm, more preferably from 5 mm to 30 mm, and the knurling height is preferably from 0.5 to 500 μm, more preferably from 1 to 200 μm. The knurling may be in a mode of single pressing or double pressing.

The film of the invention is especially suitable for use in large-panel liquid crystal display devices. In the case where the optical film is used in large-panel liquid crystal display devices, for example, it is shaped to have a film width of at least 1,470 mm. The film of the invention includes not only having a form of cut into sheets having a size capable of being directly built in a liquid crystal display device as it is, but also having a form of a long film in continuous production and wound up into a roll. The film having a form of a long film in continuous production and wound up into a roll may be stored and transported as it is, and when it is actually built in a liquid crystal display device or when it is stuck to a polarizing element, and then it is cut into a desired size. If desired, the long film may be stuck to a polarizing element of a polyvinyl alcohol produced as a long film like it, and then, when it is actually built in a liquid crystal display device, it may be cut into a desired size. In one embodiment of a roll of the film of the invention, the film having a length of at least 2,500 m is wound up into a roll film.

Thus obtained web is winded and then the cellulose acylate film is obtained as a final product.

Thus prepared, the web is wound up to give a final product, cellulose acylate film.

Preferably, the thickness of the cellulose acylate film of the invention is from 20 to 200 μm, more preferably from 20 to 60 even more preferably from 20 to 50 μm. When thinner than 20 the mechanical strength of the film may be low and the film may be broken or troubled in its production, and the film surface condition may be poor. The heat treatment effect is remarkable when the film thickness is within a range of from 20 to 200 μm.

The film thickness may be controlled to be a desired one by controlling the solid concentration in the dope, the slit gap of the die nozzle, the extrusion pressure from the die, the metal support speed, etc.

### [Polarizer]

The polarizer of the invention contains at least one film of the invention. The polarizer of the invention is described below.

The polarizer of the invention may be produced in an ordinary method. For example, one method comprises alkali-saponifying the cellulose acylate film processed to express the retardation of the invention followed by sticking it to both sides of a polarizing element with an aqueous solution of a completely-saponified polyvinyl alcohol.

The alkali saponification treatment is treatment of dipping a cellulose derivative film in a strong alkali solution at a high temperature for bettering the wettability of the film with a water-base adhesive and for enhancing the adhesiveness of the film.

Any known polarizing element may be used for the polarizer of the invention. For example, preferred for use herein is a film produced by dyeing a hydrophilic polymer such as polyvinyl alcohol or ethylene-modified polyvinyl alcohol having an ethylene unit content of from 1 to 4 mol %, a degree of polymerization of from 2000 to 4000 and a degree of saponification of from 99.0 to 99.99 mol %, with a dichroic dye such as iodine followed by stretching it, or a film produced by processing a plastic film of polyvinyl chloride or the like for orientation.

The thickness of the polarizing element is preferably from 5 to 30 μm. Thus prepared, the polarizing element is stuck to a cellulose derivative film.

In this, at least one cellulose acylate film is the retardation film of the invention. Another cellulose derivative film may be stuck to the other side of the polarizing element.

The cellulose acylate film used in producing the film of the invention may be stuck to the other side of the polarizing element, or a commercially-available cellulose ester film may be used as the polarizer protective film on the other surface of the polarizing element on the panel side.

As the polarizer protective film to be on the panel side of a display device, preferred is an antiglare film or a clear hard coat film as well as an antireflection film, an antistatic film or an antifouling film.

In producing the polarizer, the retardation film of the invention is preferably so arranged that the in-plane slow axis thereof could be in parallel to or perpendicular to the transmission axis of the polarizing element.

### [Liquid Crystal Display Device]

The liquid crystal display device of the invention contains at least one of the film of the invention or the polarizer of the invention.

The liquid crystal display device of the invention may be produced by sticking the polarizer of the invention produced in the manner as above to both sides of a liquid crystal cell. The retardation film of the invention is favorably used in TN, VA, OCB, HAN or other various driving modes of liquid crystal display devices.

Preferably, the liquid crystal display device of the invention comprises a VA-mode liquid crystal cell, a front-side substrate and a rear-side substrate, wherein the ratio of the part contrast of the front-side substrate (CR_{f}) to the part contrast of the rear-side substrate (CRᵣ), (CR_{f}/CRᵣ) is from 0.3 to 2.8.

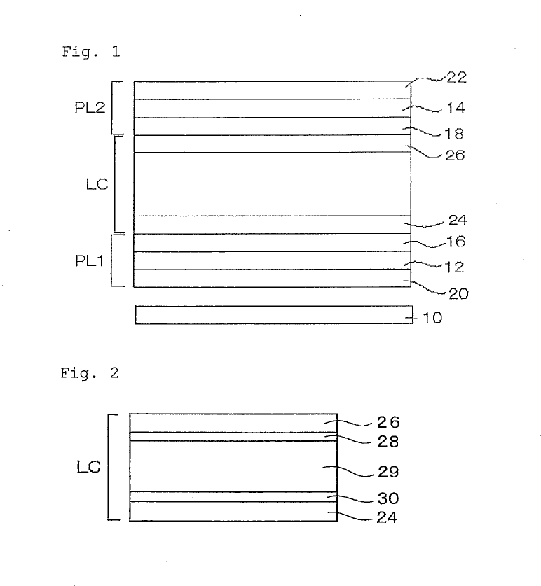

FIG. 1 shows a schematic cross-sectional view of one example of the VA-mode liquid crystal display device of the invention. In the drawing, the relative relation of the thickness of the constitutive layers does not always correspond to the relative relation of the thickness of the constitutive layers in an actual liquid crystal display device.

The VA-mode liquid crystal display device shown in FIG. 1 comprises a VA-mode liquid crystal cell LC, and a rear-side polarizer PL1 and a front-side polarizer PL2 between which the cell is sandwiched. A backlight 10 is arranged outside the rear-side polarizer PL1, and the device is so designed that the light from the backlight 10 can run through the rear-side polarizer PL1, the liquid crystal cell LC and the front-side polarizer PL2 in that order. The liquid crystal cell LC is a VA-mode liquid crystal cell, and is in homeotropic alignment at the time of black level of display. The liquid crystal cell LC is composed of an upper substrate 26 and a lower substrate 24 both of glass or the like to face each other, and the substrate has, as arranged thereon, an alignment film (not shown) and an electrode layer (not shown), and the front-side substrate further has, as arranged thereon, a color filter layer (not shown).

The rear-side polarizer PL1 comprises a polarizing element 12 and, as formed on both surfaces thereof, a first retardation film 16 and an outer protective film 20; and the front-side polarizer PL2 comprises a polarizing element 14 and, as formed on both surfaces thereof, a second retardation film 18 and an outer protective film 22. The polarizing elements 12 and 14 are so arranged that their absorption axes are perpendicular to each other. Preferably, the first retardation film 16 arranged between the polarizing element 12 of the rear-side polarizer PL1 and the liquid crystal cell LC preferably satisfies 30 nm≦Re(590)≦90 nm and 90 nm≦|Rth(590)|≦150 nm. The device may have two or more retardation films. In other words, two or more retardation films may be between the polarizing element 12 and the liquid crystal cell LC, but preferably, the total retardation of all the two or more retardation films satisfies the above-mentioned characteristics. In the VA-mode liquid crystal display device of FIG. 1, when the retardation film arranged between the polarizing element 12 and the liquid crystal cell LC satisfies the above-mentioned characteristics, the light from the backlight 10 to run obliquely into the liquid crystal cell LC is prevented from being elliptically polarized, and as a result, the device attains a high front CR.

Assiduous investigations made by the present inventors have revealed that the effect of the invention is especially remarkable in an embodiment where the ratio of the part contrast of the front-side substrate (including the substrate 26 in FIG. 1 and all the parts formed on the substrate) (CR_{f}) to the part contrast of the rear-side substrate a VA liquid crystal cell (including the substrate 24 in FIG. 1 and all the parts formed on the substrate) (CRᵣ)(CR_{f}/CRᵣ) is from 0.3 to 2.8, or that is, CR_{f}/CRᵣ is from 0.3 to 2.8. In this, when the VA-mode liquid crystal cell (LC in FIG. 1) is disassembled into two substrates (substrates 24 and 26 in FIG. 1), the front-side substrate (substrate 26 in FIG. 1) and the parts formed on the substrate are generically referred to as the front-side substrate; and the rear-side substrate (substrate 24 in FIG. 1) and the parts formed on the substrate are generically referred to as the rear-side substrate. Examples of the parts include color filter, black matrix, array part (TFT array, etc.), projections on the substrate, common electrode, slits, etc. Specifically, the part contrast of the rear-side substrate of a liquid crystal cell and that of the front-side substrate thereof each mean the total contrast of the substrate and the parts formed on the substrate. The details of the measurement method are described in Examples given below.

Assiduous investigations made by the present inventors have revealed that the retardation of the first retardation region between the rear-side polarizing element and the liquid crystal cell has a significant influence on the front CR of the liquid crystal display device. The reason is because the optical phenomena such as scattering and diffraction occurring in the parts of the liquid crystal cell (for example, liquid crystal layer, color filter, black matrix, array part, projections formed on the substrate, common electrode part, slit part, etc.) have polarization dependency. The details are described below.

In general, in the VA-mode liquid crystal display device, the liquid crystal layer is in a vertical alignment state at the time of black level of display, and therefore, the linear polarized light having passed through the rear-side polarizing element and running toward the normal direction at that time does not change its polarization state even after it has passed through the liquid crystal layer, and in principle, the light is all absorbed by the absorption axis of the front-side polarizing element. Specifically, in principle, it may be said that there occurs no light leakage in the normal line direction at the time of black level of display. However, the front transmittance at the time of black level of display of the VA-mode liquid crystal display device is not zero. It is known that one reason is because the liquid crystal molecules in the liquid crystal layer fluctuate, and the light having come into the liquid crystal layer is scattered in some degree by the fluctuation. When the light having come into the liquid crystal layer contains completely only the linear polarized component to be absorbed at the absorption axis of the front-side polarizing element, the influence may be greater and the light leakage on the front tends to increase. Specifically, when the retardation in the retardation region arranged on the rear side is larger and when the incident light is elliptically polarized at a higher elliptical polarization degree, then the light leakage on the front owing to the fluctuation can be reduced more.

However, as a result of assiduous investigations, the present inventors have known that, except the fluctuation of the liquid crystal molecules in the liquid crystal layer, the retardation in the retardation region between the rear-side polarizing element and the liquid crystal layer also contributes to the reason for light leakage. When the oriented light from the backlight has passed through the rear-side polarizing element and comes in the retardation region in an oblique direction, the linear polarized light is converted into elliptical polarized light owing to the retardation. The elliptically-polarized light is diffracted and scattered in the array part of the liquid crystal cell and in the color filter layer, and at least a part of the light comes to run in the front direction. The elliptically polarized light includes a linear polarized light component that could not be blocked at the absorption axis of the front-side polarizing element, and therefore, even at the time of black level of display, there occurs light leakage in the front direction, therefore causing a reason for front CR reduction. The optical phenomena to occur through the array part and the color filter layer are, for example, because the surface of the array part and the color filter layer is not completely smooth but is roughened in some degree and because the part may contain some scattering factors, etc. The influence of the optical phenomena to occur through the array part and the color filter layer on the light leakage in the front direction is greater than the influence thereon of the fluctuation of the liquid crystal molecules in the liquid crystal layer mentioned above.

As a result of further investigations, the present inventors have known that the optical phenomena (diffraction, scattering, etc.) to occur when the light elliptically polarized through the retardation region passes through the predetermined parts of the liquid crystal cell bring about different influence modes on the light leakage in the front direction depending on as to whether the light passes through the part before coming into the liquid crystal part or the light passes through the part after having passed through the liquid crystal layer. In FIG. 1, for example, when an array part is disposed on the inner face of the rear-side substrate 24 and a color filter is disposed on the inner face of the front-side substrate 26 as in FIG. 2, the incident light passes through the array part before coming into the liquid crystal layer, and after having passed through the liquid crystal layer, it runs through the color filter.

In the part through which the incident light passes before coming into the liquid crystal layer (e.g., array part), the degree of elliptical polarization of the incident light is determined by the retardation in the rear-side retardation region (first retardation region) through which the light passes beforehand. On the other hand, in the part through which the incident light passes after having passed through the liquid crystal layer (e.g., color filter), the degree of elliptical polarization of the incident light is determined by the retardation of the liquid crystal layer in addition to the retardation in the rear-side retardation region. In the case of a VA-mode liquid crystal display device, in general, Δnd(590) of the liquid crystal layer is defined to be from 280 to 350 nm or so. d means the thickness of the liquid crystal layer (nm); Δn(λ) means the refractivity anisotropy at a wavelength λ of the liquid crystal layer; and Δnd(2) is the product of Δn(λ) and d. Even though the retardation in the rear-side retardation region is so defined that the light leakage through the array part is reduced, the degree of elliptical polarization rather increases contrary to this, after the incident light has passed through the liquid crystal. When the retardation in the rear-side retardation region is larger, then the degree of elliptical polarization of the incident light is smaller, and therefore, depending on the part through which the incident light passes before passing through the liquid crystal layer or on the part through which the incident light passes after having passed through the liquid crystal layer, the effect for the influence of the part on the light leakage in the front direction is turned back.

The influence of the retardation in the rear-side first retardation region on the front CR is almost negligible in liquid crystal display devices having a low front CR. However, in liquid crystal display devices having a high front CR (for example, having a front CR of at least 1500) provided these days, the influence is not negligible for the purpose of further elevating the front CR. The invention is especially effective for further elevating the front CR of liquid crystal display devices having a front CR of at least 1500.

In FIG. 2 showing one example of an ordinary liquid crystal cell structure, a color filter (CF) is formed on the inner face of the front-side substrate 26 and an array part is on the inner face of the rear-side substrate 24. Apart from the ordinary liquid crystal structure illustrated, CF and the array part may be positioned in any desired sites in the liquid crystal display device of the invention. For example, needless-to-say, an embodiment where CF is disposed on the rear-side substrate having an array part thereon, like a color filter-on-array (COA) structure, falls in the scope of the invention.

As described in the above, it has been known that in an embodiment where the ratio of the part contrast of the front-side substrate (substrate 26 in FIG. 1) (CR_{f}) to the part contrast of the rear-side substrate (substrate 24 in FIG. 1) (CRᵣ), (CR_{f}/CRᵣ) satisfies 0.3 to 2.8, that is, CR_{f}/CRᵣ satisfies 0.3 to 2.8, the effect of the invention is remarkable. An example of the liquid crystal cell satisfying the relationship is a liquid crystal cell where the rear-side substrate is a COA substrate. Regarding COA, a detailed description is given in JP-A 2005-99499 and 2005-258004.

As described above, the incident light polarization state dependence of the light leakage at the time of black level of display owing to the optical phenomena at CF, black matrix, and array part every shows the same tendency; however, since the black matrix's contribution is relatively small, the position of the black matrix in a COA-structured liquid crystal display device in which CF is positioned on the side of the rear-side substrate having an array part may be in any site inside the liquid crystal cell, but is preferably between the rear-side polarizing element and the liquid crystal layer.

Examples of the liquid crystal cell that satisfies CR_{f}/CRᵣ of from 0.3 to 2.8 include a liquid crystal cell not having a color filter, and a liquid % crystal cell not having a color filter but driven in a field-sequential display mode. The field-sequential mode liquid crystal cell is described in detail in JP-A 2009-42446, 2007-322988, and Japanese Patent 3996178, which are incorporated herein by reference. In the field-sequential display mode, used are independent backlight units that sequentially emit lights of three primary colors. Preferred are backlight units each provided with LED as the light source; and for example, preferably used are backlight units each provided with an LED element emitting any of three colors of red, green and blue.

Even an ordinary liquid crystal cell where an array part is disposed on the rear-side substrate and a color filter is on the front-side substrate can be a preferred embodiment of the invention needless-to-say satisfying the above-mentioned condition of CR_{f}/CRᵣ falling from 0.3 to 2.8, so far as the color filter therein has a high contrast. One example of the color filter having a high contrast is a color filter containing a pigment having a smaller particle size than that of the pigment to be in ordinary CF. The following two methods may be mentioned as an example of producing a high-contrast color filter with a pigment.

(i) A method of mechanically more finely grinding pigment particles by the use of a disperser such as a sand mill, a roll mill, a ball mill or the like, which is described, for example, in JP-A 2009-144126, and this may be incorporated herein by reference.

(ii) A method of dissolving a pigment in a solvent followed by reprecipitating it to prepare fine pigment particles, which is described, for example, in JP-A 2009-134178.

Except pigment, a method of producing a high-contrast color filter with dye is proposed. It is described in detail in JP-A 2005-173532, which may be incorporated herein by reference.

Use of the contract-increased color filter may make an ordinary liquid crystal cell satisfy 3≦CR_{f}/CRᵣ.

Again FIG. 1 is referred to. Preferably, the optical properties of the second retardation film 18 which the front-side polarizer PL2 has can contribute toward elevating the contrast in oblique directions and reducing the color shift at the time of black level of display. Δnd(λ) of the liquid crystal layer in the VA-mode liquid crystal cell LC is, as described above, generally from 280 to 350 nm or so. The preferred range of the retardation, especially Rth of the second retardation film 18 varies depending on the value of λnd(λ) of the liquid crystal layer. The preferred combination of the retardation films relative to λnd(λ) for elevating the oblique contrast is described in various patent publications, for example, in Japanese Patents 3282986, 3666666 and 3556159, which may be incorporated herein by reference.

Preferred ranges of the optical properties of the second retardation region are the same as the preferred ranges of the optical properties of the first retardation region; and preferably, two films of the invention are used as the first retardation region and the second retardation region.

λnd(590) of a VA-mode liquid crystal cell is generally from 280 to 350 nm or so, and this is for increasing as much as possible the transmittance at the time of white level of display. On the other hand, when λnd(590) is less than 280 nm, the white brightness may decrease slightly along with the reduction in Δnd(590), but since the cell thickness d is small, the liquid crystal display device can be excellent in rapid responsibility. The characteristic feature of the invention of attaining a high front CR is effective in any liquid crystal display devices having different Δnd(590).

In the embodiment of a VA-mode liquid crystal display device of FIG. 1, the first retardation film 16 and the second retardation film 18 each function as the protective film for the polarizing elements 12 and 14, respectively. However, the invention is not limited to this embodiment. For example, an additional protective film for the polarizing element may be arranged between the first retardation film or the second retardation film and the polarizing element 12 or 14.

The rear-side polarizing element 12 may have the protective film 20 on the surface thereof facing the backlight 10, and may additionally have further thereon any functional film such as antifouling film, antireflection film, antiglare film, antistatic film, etc.; and similarly, the front-side polarizing element 14 generally has the protective film 22 on the surface thereof facing the panel side, and may additionally have further thereon any functional film such as antifouling film, antireflection film, antiglare film, antistatic film, etc.

The VA-mode liquid crystal display device of the invention can be driven in any mode, concretely in any mode of MVA (Multi-Domain Vertical Alignment), PVA (Patterned Vertical Alignment), OP (Optical Alignment) or PSA (Polymer-Sustained Alignment). The details of these modes are described in JP-A 2006-215326, and JP-T 2008-538819.

As described in the above, a high-contrast color filter may be used in the invention, but needless-to-say, a color filter that ordinary liquid crystal display devices have may also be used here. The color filter generally have two or more different colors (for example, three primary colors of light, red, green and blue; and transparent, yellow, cyan, etc.) in the pixel sites of the substrate. Various methods are known for its production. For example, in one general method using a coloring material (organic pigment, dye, carbon black, etc.), a color photosensitive composition referred to as a color resist (this may also be a transparent one) is prepared, and this is applied onto a substrate to form a layer thereon, and is patterned through photolithography. Various methods are also known for applying the color photosensitive composition onto a substrate. For example, in the early stages, a spin coater method was employed; and from the viewpoint of chemical saving, a slit-and-spin coater method has become employed; and at present, a slit coater method is generally employed. In addition, also usable are a roll coating method, a bar coating method, a die coating method, etc. Recently, a method has become used where a pattern referred to as a partition wall is formed through photolithography and color pixels are formed according to an inkjet process. In addition, also known are a method of using both a color non-photosensitive composition and a photosensitive positive resist as combined, a printing method, an electrodeposition method, a film transfer method. The color filter for use in the invention may be produced in any method.

### EXAMPLES

The characteristics of the invention are described more concretely with reference to the following Examples. In the following Examples, the material used, its amount and the ratio, the details of the treatment and the treatment process may be suitably modified or changed. Accordingly, the invention should not be limitatively interpreted by the Examples mentioned below.

In the invention, the samples were analyzed to measure their properties according to the following measurement methods.

### (Optical Expressibility)

Using KOBRA 21ADH (by Oji Scientific Instruments), Re and Rth of samples are measured at a wavelength of 590 nm. The results are shown in Table 5 below.

### (Total Haze)

A film sample 40 mm×80 mm of the invention is analyzed with a haze meter (HGM-2DP, by Suga Test Instruments) at 25° C. and a relative humidity of 60% to measure the total haze thereof according to JIS K-6714. The results are shown in Table 5 below.

### (Internal Haze)

A few drops of glycerin are applied onto both surfaces of the cellulose acylate film to be analyzed, the film is sandwiched between two glass plates (MICRO SLIDE GLASS Lot No. S9243, by Matsunami) each having a thickness of 1.3 mm, and the haze value (%) of the sample is measured. On the other hand, a few drops of glycerin are put between two glass plates, and the haze value (%) thereof is measured. The latter value is subtracted from the former value to give the internal haze value (%) of the film sample. The results are shown in Table 5 below.

### Example 1 to 11 and Comparative Example 1 to 16

### (1) Preparation of Cellulose Acylate Resin by Synthesizing

Cellulose acylate was prepared, of which the degree of substitution is shown in the following Table 5. Concretely, a catalyst, sulfuric acid (in an amount of 7.8 parts by mass relative to 100 parts by mass of cellulose) was added to cellulose, and then each carboxylic acid to give the acyl group was added thereto, and the cellulose was acylated at 40° C. In this, the type and the amount of the carboxylic acid were changed to thereby change and control the total degree of substitution and the degree of 6-position substitution. After the acylation, the product was aged at 40° C. The low-molecular component was removed from the cellulose acylate by washing with acetone.

### (2) Preparation of Dope

The following composition was put into a mixing tank and stirred to dissolve the ingredients. After heated at 90° C. for about 10 minutes, this was filtered through a paper filter having a mean pore size of 34 μm and a sintered metal filter having a mean pore size of 10 μm.

Cellulose Acylate Solution for Example 1

| | |
|---|---|
| Cellulose acylate in Table 5 below | 100.0 mas. pts. |
| Sugar ester (1) in Table 5 below | 8.0 mas. pts. |
| Polyester (1) in Table 5 below | 1.5 mas. pts. |
| Methylene chloride | 403.0 mas. pts. |
| Methanol | 60.2 mas. pts. |

In Table 5 below, Ac represents an acetyl group, Pr represents a propionyl group.

### (Matting Agent Dispersion)

The following composition containing the cellulose acylate solution that had been prepared according to the above method was put into a disperser and dispersed to prepare a matting agent dispersion.

Matting Agent Dispersion for Example 1

| | |
|---|---|
| Matting agent (Aerosil R972) | 0.2 mas. pts. |
| Methylene chloride | 72.4 mas. pts. |
| Methanol | 10.8 mas. pts. |
| Cellulose acylate solution | 10.3 mas. pts. |

100 parts by mass of the above cellulose acylate solution for Example 1 and matting agent dispersion for Example 1 in such an amount that the amount of the inorganic particle could be 0.02 parts by mass against the cellulose acylate resin were mixed to prepare a dope for film formation.

Dopes of other Examples and Comparative Examples were prepared in the same manner as that for the dope of Example 1, for which, however, the type of the thermoplastic resin, and the amount of the additive were changed as in Table 5 below. Comparative Examples 3 to 9 are Films No. 1 to No. 7 in Examples of WO2008-126535. Comparative Examples 10 to 16 are modifications of Films No. 1 to No. 7 in Examples of WO2008-126535, for which the heat treatment temperature was changed as in Table 5 below.

### Polyester (1):

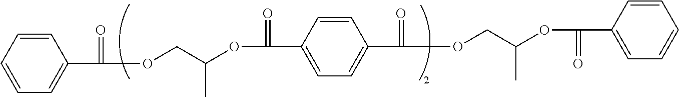

### Polyalcohol Ester (1):

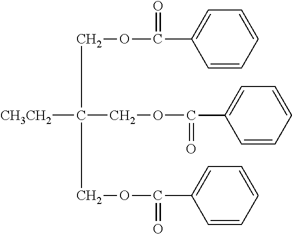

### (3) Casting

The above-mentioned dope was cast, using a band caster. The band is made of SUS.

### (4) Drying

The cast web (film) was dried for 20 minutes on the band before peeling, at the temperature indicated in Table 5 below, using a drying apparatus. In a different embodiment, the web was peeled from the band, and then dried for 20 minutes in a tenter apparatus where the web was clipped on both sides thereof and conveyed therein. In these two embodiments, the results were the same. The drying temperature is the film surface temperature.

### (5) Stretching

The formed web (film) was peeled from the band, clipped, and stretched under the condition of side-fixed monoaxial stretching, in the direction perpendicular to the film transferring direction (transverse direction) at the stretching temperature and the draw ratio indicated in Table 5 below, while the residual solvent amount was from 30 to 5% relative to the total mass of the film, using a tenter.

Subsequently, the film was unclipped and dried at 110° C. for 30 minutes. In this, the casting thickness was so controlled that the thickness (unit, μm) of the stretched film could be as in Table 5. The film having the composition shown in Table 5 was produced, and for the purpose of determining its production aptitude, at least 24 rolls of the film each having a roll width of 1280 mm and a roll length of 2600 mm were produced under the condition as above. Of those 24 rolls continuously produced, one roll was sampled at intervals of 100 m to give samples each having a length of 1 m (width of 1280 mm), and these were analyzed as above.

### (Production of Polarizer)

Iodine was made to be adsorbed by a stretched polyvinyl alcohol film to give a polarizing element. The film of Examples and Comparative Examples was stuck to one side of the polarizing element, using a polyvinyl alcohol adhesive. The film was saponified under the condition mentioned below.

An aqueous solution of sodium hydroxide (1.5 mol/L) was prepared and kept warmed at 55° C. An aqueous solution of diluted sulfuric acid (0.005 mol/L) was prepared and kept warmed at 35° C. The film produced in Examples and Comparative Examples was dipped in the aqueous solution of sodium hydroxide for 2 minutes, and then dipped in water to fully remove the aqueous solution of sodium hydroxide. Subsequently, the film was dipped in the aqueous solution of diluted sulfuric acid for 1 minute, and then dipped in water to fully remove the aqueous solution of diluted sulfuric acid. Finally, the sample was fully dried at 120° C.

A commercially-available cellulose acylate film (Fujitac TD80UF, by FUJIFILM) was saponified, and stuck to the opposite side of the polarizing element using a polyvinyl alcohol adhesive, and dried at 70° C. for 10 minutes or more.

The polarizing element and the film of Examples and Comparative Examples were so arranged that the transmission axis of the former could be parallel to the slow axis of the latter. The polarizing element and the commercial cellulose acylate film were so arranged that the transmission axis of the former could be perpendicular to the slow axis of the latter.

### (Manufacturing of Liquid Crystal Display Device)

According to Example 20 described in JP-A 2009-141341, a TFT element was formed on a glass substrate, and a protective film was formed on the TFT element. Subsequently, a contact hole was formed in the protective film, and then a transparent electrode of ITO was formed, as electrically connected to the TFT element, on the protective film, thereby producing an array substrate.

Using a coloring photosensitive composition prepared according to Examples 17, 18 and 19 in JP-A 2009-144126 and according to the process described in Example 9a in JP-T 2008-516262, [0099]-[0103], a color filter substrate was produced.

On the color filter substrate produced in the above, formed was a transparent electrode of ITO through sputtering. Next, according to Example 1 in JP-A 2006-64921, a spacer was formed on the ITO film in the area corresponding to the upper part of the partitioning wall (black matrix).

The transparent electrode of the array substrate and the color filter substrate was patterned for PVA mode, and a vertical alignment film of polyimide was formed thereon.

Afterwards, a UV-curable resin sealant was applied to the position corresponding to the black matrix frame disposed in the periphery to surround the RGB pixel group of the color filter, according to a dispenser system, then a PVA-mode liquid crystal was dropwise applied thereto, and the substrate was stuck to the array substrate. The thus-stuck substrates were irradiated with UV and heat-treated to cure the sealant. According to the process, a liquid crystal cell was produced.

Subsequently, Δnd(550) of the thus-produced liquid crystal cell was measured with AXOMETRICS' AXOSCAN using the associated software, and the cell, of which Δnd(550) is 300 nm, was selected. This was used as Liquid Crystal Cell 1.

As the light source for Liquid Crystal Cell 1, used was the backlight used in the LC-32GH5, and the light source was disposed on the side of the array substrate.

(Computation of Member Contrast ratio of the Front-side Substrate and the Rear-Side Substrate of the Liquid Crystal Cell)

Liquid Crystal Cell 1 was disassembled, and then the substrate disposed to viewer side was the front-side substrate and the substrate disposed to light source side was the rear-side substrate; and each substrate was washed with ethanol to use for commutation of the member contrast ratio of the front-side substrate and the rear-side substrate according to the following method.

A polarizer (HLC2-2518, by Sanritz) was put on the backlight of a liquid crystal panel, Sharp's LC-32DE5, and on this, the front-side substrate or the rear-side substrate prepared by disassembling Liquid Crystal Cell 1, as fitted to a rotary stage SGSP-120YAW (by Sigma Koki), was disposed in parallel to each other at a distance of 2 mm from the polarizer. Briefly, these were so disposed that the array wiring on the substrate and the lattice pattern of the black matrix could correspond to the polarization axis of the polarizer. Further on this, a polarizer, HLC2-2518 (by Sanritz) fitted to a rotary stage was disposed so that the distance between the polarizers could be 52 mm. Using a tester BM5A (by TOPCON) in a dark room, the brightness at the time of black level and white level of display in the normal direction was measured, and the front contrast ratio A (white brightness/black brightness) was computed. In this, the polarizer was rotated, and the lowest brightness was the brightness at the time of black level of display. Then, the polarizer was rotated by 90 degrees, and the brightness in this stage was the brightness at the time of white level of display.

Next, in the above embodiment, the front-side substrate or the rear-side substrate was removed, and the brightness at the time of black level or white level of display with the polarizer alone was measured, and the front contrast ratio B was computed.

To remove the influence of the front contrast ratio B with the polarizer on the front contrast ratio A, the member contrast ratio was computed according to the following formula:

Member Contrast Ratio=1/{(1/front contrast ratio A)−(1/front contrast ratio B)}.

The member contrast ratio of Liquid Crystal Cell 1 was 2.0.

(Contrast of Assembled Liquid Crystal Display Devices after Manipulation of Polarizer)

The front contrast ratio of the liquid crystal display device having a Liquid Crystal Cell 1 as a VA-mode liquid crystal cell was computed.

Using a tester BM5A (by TOPCON) in a dark room, the brightness at the time of black level and white level of display in the normal direction to the panel was measured, and from the data, the front contrast ratio (white brightness/black brightness) was computed.

The result was shown in Table 5 below.

TABLE 5

| | | | | | | | | | Temperature of |
|---|---|---|---|---|---|---|---|---|---|
| | Cellulose acylate | | | | | | | | drying or heat |
| | Degree of | Degree of | Total | | Additives 1 | | Additives 2 | | treatment |
| | Substitution | Substitution | Substitution | mas. | | mas. | | mas. | before |
| | of Ac | of Pr | degree | pts. | Compound | pts. | Compound | pts. | stretching (° C.) |
| EX. 1 | 1.6 | 0.9 | 2.5 | 100 | Sugar ester (1) | 8 | Polyester (1) | 1.5 | 158 |
| EX. 2 | 1.6 | 0.9 | 2.5 | 100 | Sugar ester (1) | 8 | Polyester (1) | 1.5 | 158 |
| EX. 3 | 1.6 | 0.9 | 2.5 | 100 | Sugar ester (1) | 8 | Polyester (1) | 1.5 | 155 |
| EX. 4 | 1.6 | 0.9 | 2.5 | 100 | Sugar ester (2) | 8 | Polyester (1) | 1.5 | 158 |
| EX. 5 | 1.6 | 0.9 | 2.5 | 100 | Sugar ester (3) | 8 | Polyester (1) | 1.5 | 155 |
| EX. 6 | 1.6 | 0.9 | 2.5 | 100 | Sugar ester (4) | 8 | Polyester (1) | 1.5 | 155 |
| EX. 8 | 0.5 | 1.5 | 2.0 | 100 | Sugar ester (1) | 8 | Polyester (1) | 1.5 | 148 |
| EX. 9 | 0.5 | 1.5 | 2.0 | 100 | Sugar ester (2) | 8 | Polyester (1) | 1.5 | 147 |
| EX. 10 | 0.5 | 1.5 | 2.0 | 100 | Sugar ester (3) | 8 | Polyester (1) | 1.5 | 147 |
| EX. 11 | 0.5 | 1.5 | 2.0 | 100 | Sugar ester (4) | 8 | Polyester (1) | 1.5 | 147 |
| EX. 12 | 1.6 | 0.9 | 2.5 | 100 | Sugar ester (1) | 8 | — | — | |
| EX. 13 | 1.6 | 0.9 | 2.5 | 100 | Sugar ester (2) | 8 | — | — | |
| EX. 14 | 1.6 | 0.9 | 2.5 | 100 | Sugar ester (3) | 8 | — | — | |
| EX. 15 | 1.6 | 0.9 | 2.5 | 100 | Sugar ester (4) | 8 | — | — | |
| Comp. Ex. 1 | 1.6 | 0.9 | 2.5 | 100 | Sugar ester (1) | 8 | Derivative of | 1.5 | 158 |
| | | | | | | | propylene | | |
| | | | | | | | dibenzoate | | |
| Comp. Ex. 2 | 1.6 | 0.9 | 2.5 | 100 | Sugar ester (1) | 8 | Derivative of | 1.5 | 158 |
| | | | | | | | propylene | | |
| | | | | | | | dibenzoate | | |
| Comp. Ex. 3 | 1.2 | 1.2 | 2.4 | 100 | Polyester (1) | 5 | Polyalcohol ester (1) | 5 | 195 |
| Comp. Ex. 4 | 1.2 | 1.2 | 2.4 | 100 | Polyester (1) | 5 | Polyalcohol ester (1) | 5 | 185 |
| Comp. Ex. 5 | 1.2 | 1.2 | 2.4 | 100 | Polyester (1) | 5 | Polyalcohol ester (1) | 5 | 175 |
| Comp. Ex. 6 | 1.2 | 1.2 | 2.4 | 100 | Polyester (1) | 5 | Polyalcohol ester (1) | 5 | 165 |
| Comp. Ex. 7 | 1.2 | 1.2 | 2.4 | 100 | Polyester (1) | 5 | Polyalcohol ester (1) | 5 | 165 |
| Comp. Ex. 8 | 1.2 | 1.2 | 2.4 | 100 | Polyester (1) | 5 | Polyalcohol ester (1) | 5 | 175 |
| Comp. Ex. 9 | 1.2 | 1.2 | 2.4 | 100 | Polyester (1) | 5 | Polyalcohol ester (1) | 5 | 185 |
| Comp. Ex. 10 | 1.2 | 1.2 | 2.4 | 100 | Polyester (1) | 5 | Polyalcohol ester (1) | 5 | 145 |
| Comp. Ex. 11 | 1.2 | 1.2 | 2.4 | 100 | Polyester (1) | 5 | Polyalcohol ester (1) | 5 | 145 |
| Comp. Ex. 12 | 1.2 | 1.2 | 2.4 | 100 | Polyester (1) | 5 | Polyalcohol ester (1) | 5 | 145 |
| Comp. Ex. 13 | 1.2 | 1.2 | 2.4 | 100 | Polyester (1) | 5 | Polyalcohol ester (1) | 5 | 145 |
| Comp. Ex. 14 | 1.2 | 1.2 | 2.4 | 100 | Polyester (1) | 5 | Polyalcohol ester (1) | 5 | 145 |
| Comp. Ex. 15 | 1.2 | 1.2 | 2.4 | 100 | Polyester (1) | 5 | Polyalcohol ester (1) | 5 | 145 |
| Comp. Ex. 16 | 1.2 | 1.2 | 2.4 | 100 | Polyester (1) | 5 | Polyalcohol ester (1) | 5 | 145 |

| | | Stretching condition | | | | | Haze | | Front |
|---|---|---|---|---|---|---|---|---|---|
| | | | Stretching | | Retardation | | Total | Internal | contrast |
| | Tg | Temperture | ratio | Thickness | Re | Rth | haze | haze | ratio |
| | (° C.) | (° C.) | (%) | (μm) | (nm) | (nm) | (%) | (%) | (%) |
| EX. 1 | 165 | 160 | 30 | 40 | 48 | 123 | 0.2 | 0.04 | 6657 |
| EX. 2 | 165 | 165 | 30 | 42 | 47 | 120 | 0.2 | 0.05 | 6609 |
| EX. 3 | 165 | 175 | 30 | 42 | 47 | 99 | 0.5 | 0.07 | 6492 |
| EX. 4 | 165 | 160 | 30 | 50 | 43 | 113 | 0.4 | 0.02 | 6730 |
| EX. 5 | 165 | 160 | 30 | 50 | 41 | 122 | 0.6 | 0.05 | 6585 |
| EX. 6 | 165 | 160 | 30 | 50 | 48 | 139 | 0.5 | 0.08 | 6446 |
| EX. 8 | 155 | 150 | 30 | 35 | 55 | 140 | 0.3 | 0.04 | 6633 |
| EX. 9 | 155 | 150 | 30 | 35 | 54 | 136 | 0.5 | 0.03 | 6705 |
| EX. 10 | 155 | 150 | 30 | 35 | 54 | 113 | 0.7 | 0.06 | 6562 |
| EX. 11 | 155 | 150 | 30 | 35 | 49 | 129 | 0.5 | 0.09 | 6424 |
| EX. 12 | 168 | 160 | 30 | 40 | 44 | 113 | 0.2 | 0.03 | 6670 |
| EX. 13 | 165 | 160 | 30 | 50 | 43 | 110 | 0.2 | 0.04 | 6626 |
| EX. 14 | 165 | 160 | 30 | 50 | 44 | 91 | 0.5 | 0.06 | 6518 |
| EX. 15 | 165 | 160 | 30 | 50 | 39 | 104 | 0.4 | 0.02 | 6738 |
| Comp. Ex. 1 | 165 | 155 | 30 | 42 | 51 | 137 | 0.2 | 0.13 | 6249 |
| Comp. Ex. 2 | 165 | 185 | 30 | 50 | 52 | 95 | 0.8 | 0.11 | 6313 |
| Comp. Ex. 3 | 155 | 155 | 36 | 50 | 52 | 90 | 0.35 | 0.10 | 6357 |
| Comp. Ex. 4 | 155 | 145 | 26 | 50 | 40 | 100 | 0.1 | 0.05 | 6585 |
| Comp. Ex. 5 | 155 | 145 | 26 | 45 | 42 | 150 | 0.2 | 0.04 | 6633 |
| Comp. Ex. 6 | 155 | 150 | 36 | 45 | 50 | 110 | 0.3 | 0.10 | 6357 |
| Comp. Ex. 7 | 155 | 165 | 36 | 40 | 40 | 100 | 0.4 | 0.15 | 6144 |
| Comp. Ex. 8 | 155 | 135 | 36 | 45 | 55 | 120 | 0.3 | 0.15 | 6144 |
| Comp. Ex. 9 | 155 | 160 | 36 | 150 | 150 | 320 | 0.3 | 0.15 | 6144 |
| Comp. Ex. 10 | 155 | 155 | 36 | 50 | 53 | 101 | 1.35 | 0.80 | 4282 |
| Comp. Ex. 11 | 155 | 145 | 26 | 50 | 40 | 115 | 1 | 0.68 | 4535 |
| Comp. Ex. 12 | 155 | 145 | 26 | 45 | 41 | 158 | 0.9 | 0.53 | 4898 |
| Comp. Ex. 13 | 155 | 150 | 36 | 45 | 51 | 123.5 | 1.4 | 0.87 | 4146 |
| Comp. Ex. 14 | 155 | 165 | 36 | 40 | 40 | 114 | 0.9 | 0.50 | 4978 |
| Comp. Ex. 15 | 155 | 135 | 36 | 45 | 54 | 133 | 1.1 | 0.71 | 4469 |
| Comp. Ex. 16 | 155 | 160 | 36 | 150 | 152 | 325 | 0.9 | 0.57 | 4796 |

From Table 5, it is known that the front contrast of the liquid crystal display device with the cellulose acylate film of the invention incorporated therein was comparable to or higher than that in Comparative Examples 1 to 9, even though the films of the invention were not heated at all at a temperature higher than Tg−5° C. before stretched. The data in Comparative Examples 10 to 16 indicate that, when the films of Examples in WO2008-126535, or that is, the films of Comparative Examples 3 to 9 herein are not heat-treated, the front contrast of the liquid crystal display device with the film incorporated therein is extremely low.

### Examples 201, 202, 301 and 302, and Comparative Examples 212 and 312

### Manufacturing of other VA-mode Liquid Crystal Display Device

The film obtained in Examples 1 and 2 and Comparative Example 12 was disposed in the other VA-mode liquid crystal display device which has following constitution. The films of the Example and Comparative Example were used 2 sheets at a time in the following VA-mode liquid crystal display device.

### Preparation of VA-mode Liquid Crystal Cell 2:

The Liquid Crystal Cell 2 was manufactured in the same way as the Liquid Crystal Cell 1 but changing the array substrate which has different TFT element constitution and changing the color filter substrate which was produced by using a coloring photosensitive composition prepared according to Examples 2, and Comparative Example 6 in JP-A 2009-144126.

Subsequently, Δnd(550) of the thus-produced liquid crystal cell was measured with AXOMETRICS' AXOSCAN using the associated software, and the cell, of which Δnd(550) is 300 nm, was selected. This was used as Liquid Crystal Cell 2.

As the light source for Liquid Crystal Cell 2, used was the backlight used in the above LCG-32 GH5, and the light source was disposed on the side of the array substrate.

### Preparation of VA-mode Liquid Crystal Cell 3:

The Liquid Crystal Cell 3 was manufactured in the same way as the Liquid Crystal Cell 1 but changing the array substrate which has different TFT element constitution and changing the color filter substrate which was produced by using a coloring photosensitive composition prepared according to Examples 14, 22 and 27 in JP-A 2009-203462.

Subsequently, Δnd(550) of the thus-produced liquid crystal cell was measured with AXOMETRICS' AXOSCAN using the associated software, and the cell, of which Δnd(550) is 300 nm, was selected. This was used as Liquid Crystal Cell 3.

As the light source for Liquid Crystal Cell 3, used was the backlight used in the above LCG-32GH5, and the light source was disposed on the side of the array substrate.

TABLE 6

| Kinds of liquid crystal cell | Δnd(590) (nm) | CRf/CRr |
|---|---|---|
| Liquid Crystal Cell 1 | 300 | 2.0 |
| Liquid Crystal Cell 2 | 300 | 0.4 |
| Liquid Crystal Cell 3 | 300 | 3.0 |

The results when the Liquid Crystal Cell 2 and Liquid Crystal Cell 3 were used are shown in Table 7 below with the results of Examples 1 and 2 and Comparative Example 12, in which the Liquid Crystal Cell 1 was used.

TABLE 7

| | | | | haze | | | | Front |
|---|---|---|---|---|---|---|---|---|
| | Cellulose | Retardation | | Total | Internal | | | contrast |
| | acylate | Re | Rth | haze | haze | Liquid crystal | | ratio |
| | film No. | (nm) | (nm) | (%) | (%) | cell | CRf/CRr | (%) |
| Ex. 1 | Ex. 1 | 48 | 123 | 0.2 | 0.04 | Liquid Crystal | 2.0 | 6657 |
| | | | | | | Cell 1 | | |
| Ex. 2 | Ex. 2 | 47 | 120 | 0.2 | 0.05 | Liquid Crystal | 2.0 | 6609 |
| | | | | | | Cell 1 | | |
| Comp. | Comp. | 41 | 158 | 0.9 | 0.53 | Liquid Crystal | 2.0 | 4898 |
| Ex. 12 | Ex. 12 | | | | | Cell 1 | | |
| Ex. 201 | Ex. 1 | 48 | 123 | 0.2 | 0.04 | Liquid Crystal | 0.4 | 6590 |
| | | | | | | Cell 2 | | |
| Ex. 202 | Ex. 2 | 47 | 120 | 0.2 | 0.05 | Liquid Crystal | 0.4 | 6543 |
| | | | | | | Cell 2 | | |
| Comp. | Comp. | 41 | 158 | 0.9 | 0.53 | Liquid Crystal | 0.4 | 4898 |
| Ex. 212 | Ex. 12 | | | | | Cell 2 | | |
| Ex. 301 | Ex. 1 | 48 | 123 | 0.2 | 0.04 | Liquid Crystal | 3.0 | 6524 |
| | | | | | | Cell 3 | | |
| Ex. 302 | Ex. 2 | 47 | 120 | 0.2 | 0.05 | Liquid Crystal | 3.0 | 6477 |
| | | | | | | Cell 3 | | |
| Comp. | Comp. | 41 | 158 | 0.9 | 0.53 | Liquid Crystal | 3.0 | 4654 |
| Ex. 312 | Ex. 12 | | | | | Cell 3 | | |

From the result of Table 7, it was found that the particularly good contrast was shown when the film of the invention was used with a VA-mode cell having the ratio of the member-contrast ratio of the front-side substrate CR_{f} to the member-contrast ratio of the rear-side substrate CRᵣ, CR_{f}/CRᵣ is from 0.3 to 2.8.

The present disclosure relates to the subject matter contained in Japanese Patent Application No. 282653/2009 filed on Dec. 14, 2009, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose acylate film comprising a cellulose acylate and a sugar ester compound, which is stretched at (Tg−5° C.) to (Tg+10° C.) while as yet not heated at all at (Tg−5° C.) or higher and which has a total haze of at most 1.0% and an internal haze of at most 0.1%, wherein Tg means the glass transition temperature (unit: ° C.) of the cellulose acylate film.

2. The cellulose acylate film according to claim 1, wherein the sugar ester compound comprises from 1 to 12 units of a pyranose structural unit or a furanose structure unit in which at least one hydroxyl group is esterified.

3. The cellulose acylate film according to claim 1, wherein the sugar ester compound is represented by the following formula (1):
(OH)ₚ-G-(L¹-R¹¹)_{q}(OR¹²)ᵣ (1)
wherein G represents a sugar residue; L¹ represents any one of —O—, —CO— or —NR¹³—; R¹¹ represents a hydrogen atom or a monovalent substituent; R¹² represents a monovalent substituent bonding to the formula via an ester bond; p, q and r each independently indicate an integer of 0 or more, and p+q+r is equal to the number of the hydroxyl groups on the presumption that G is an unsubstituted sugar group having a cyclic acetal structure.

4. The cellulose acylate film according to claim 1, wherein the sugar ester compound is represented by the following formula: 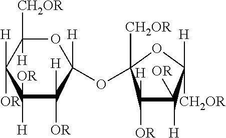
wherein R's each independently represent a hydrogen atom, an acetyl group, a benzyl group, a benzoyl group or a phenylacetyl group provided that at least one R is not a hydrogen atom.

5. The cellulose acylate film according to claim 1, wherein the sugar ester compound is represented by the following formula: 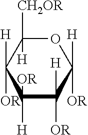
wherein R's each independently represent a hydrogen atom, an acetyl group, a benzyl group, a benzoyl group or a phenylacetyl group provided that at least one R is not a hydrogen atom.

6. The cellulose acylate film according to claim 1, wherein the sugar ester compound is represented by the following formula: 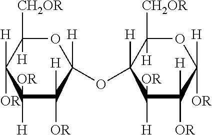
wherein R's each independently represent a hydrogen atom, an acetyl group, a benzyl group, a benzoyl group or a phenylacetyl group provided that at least one R is not a hydrogen atom.

7. The cellulose acylate film according to claim 1, wherein the sugar ester compound is represented by the following formula: 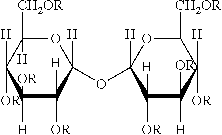
wherein R's each independently represent a hydrogen atom, an acetyl group, a benzyl group, a benzoyl group or a phenylacetyl group provided that at least one R is not a hydrogen atom.

8. The cellulose acylate film according to claim 1, wherein the sugar ester compound has a number-average molecular weight of from 200 to 3500.

9. The cellulose acylate film according to claim 1, wherein the sugar ester compound is contained in an amount of from 2 to 30% by mass relative to the cellulose acylate contained in the film.

10. The cellulose acylate film according to claim 1, which has a total haze of at most 0.4%.

11. The cellulose acylate film according to claim 1, wherein the cellulose acylate satisfies the following formulae (1) and (2):
2.00≦A+B≦2.80 (1)
0.50≦B (2)
wherein A means a degree of acetyl substitution, and B means a degree of propionyl substitution or butyryl substitution.

12. The cellulose acylate film according to claim 1, of which the in-plane retardation at a wavelength of 590 nm Re(590) and the thickness-direction retardation at a wavelength of 590 nm Rth(590) satisfy the following formulae (3) and (4):
30 nm≦Re(590)≦90 nm (3)
90 nm≦Rth(590)≦150 nm. (4)

13. The cellulose acylate film according to claim 1, which comprises a polyester-based plasticizer.

14. A method for producing an optical film, which comprises stretching a film comprising a cellulose acylate and a sugar ester compound at (Tg−5° C.) to (Tg+10° C.) while as yet the film is not heated at all at (Tg−5° C.) or higher, wherein Tg means the glass transition temperature (unit: ° C.) of the cellulose acylate film.

15. The method for producing an optical film according to claim 14, wherein the sugar ester compound comprises from 1 to 12 units of a pyranose structural unit or a furanose structure unit in which at least one hydroxyl group is esterified.

16. The method for producing an optical film according to claim 14, wherein the stretching temperature is from (Tg−5° C.) to (Tg+5° C.) wherein Tg means the glass transition temperature of the cellulose acylate film.

17. A cellulose acylate film produced by stretching a film comprising a cellulose acylate and a sugar ester compound at (Tg−5° C.) to (Tg+10° C.) while as yet the film is not heated at all at (Tg−5° C.) or higher, wherein Tg means the glass transition temperature (unit: ° C.) of the cellulose acylate film.

18. A polarizer comprising a polarizing element and at least one cellulose acylate film wherein the cellulose acylate film comprises a cellulose acylate and a sugar ester compound, which is stretched at (Tg−5° C.) to (Tg+10° C.) while as yet not heated at all at (Tg−5° C.) or higher and which has a total haze of at most 1.0% and an internal haze of at most 0.1%, wherein Tg means the glass transition temperature (unit: ° C.) of the cellulose acylate film.

19. A liquid crystal display device comprising at least one of the cellulose acylate film wherein the cellulose acylate film comprises a cellulose acylate and a sugar ester compound, which is stretched at (Tg−5° C.) to (Tg+10° C.) while as yet not heated at all at (Tg−5° C.) or higher and which has a total haze of at most 1.0% and an internal haze of at most 0.1%, wherein Tg means the glass transition temperature (unit: ° C.) of the cellulose acylate film.

20. The liquid crystal display device according to claim 19, which comprises a VA-mode liquid crystal cell, a front-side substrate and a rear-side substrate and wherein the ratio of the part contrast of the front-side substrate (CR_{f}) to the part contrast of the rear-side substrate (CRᵣ)(CR_{f}/CRᵣ) is from 0.3 to 2.8.
